(19) United States
(12) Patent Application Publication
(10) Pub. No.: US 2026/0371112 A1
(43) Pub. Date: Nov. 19, 2026

(54) SIDELINK-ASSISTED ARTIFICIAL INTELLIGENCE/ MACHINE LEARNING MONITORING

(71) Applicants: Hamed PEZESHKI, San Diego, CA (US); Qiaoyu LI, Beijing (CN); Mahmoud TAHERZADEH BOROUJENI, San Diego, CA (US)

(72) Inventors: Hamed PEZESHKI, San Diego, CA (US); Qiaoyu LI, Beijing (CN); Mahmoud TAHERZADEH BOROUJENI, San Diego, CA (US)

(21) Appl. No.: 19/476,089

(22) PCT Filed: May 23, 2023
(86) PCT No.: PCT/CN2023/095682

§ 371 Date: Oct. 16, 2025

(51) Int. Cl. H04W 24/02; H04L 41/16; H04W 72/25; H04W 92/18

(52) U.S. Cl. CPC H04W 24/02; H04L 41/16; H04W 72/25; H04W 92/18

(57) ABSTRACT

In some implementations, a first user equipment (UE) may receive, from a second UE via a sidelink, monitoring information associated with an artificial intelligence (AI)/machine learning (ML) model of the second UE. The UE may perform a monitoring procedure associated with an AI/ML model of the first UE based at least in part on the monitoring information associated with the AI/ML model of the second UE. Numerous other aspects are described.

### FIELD OF THE DISCLOSURE

Aspects of the present disclosure generally relate to wireless communication and to techniques and apparatuses for using sidelink communication to facilitate and/or enhance an artificial intelligence/machine learning model monitoring procedure at a user equipment.

### BACKGROUND

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and types of wireless communications mediums available for use, and the like. Consequently, there exists a need for further improvements in wireless communications systems to overcome the aforementioned technical challenges and others.

### SUMMARY

Some aspects described herein relate to a method of wireless communication performed by a first user equipment (UE). The method may include receiving, from a second UE via a sidelink, monitoring information associated with an artificial intelligence (AI)/machine learning (ML) model of the second UE. The method may include performing a monitoring procedure associated with an AI/ML model of the first UE based at least in part on the monitoring information associated with the AI/ML model of the second UE.

Some aspects described herein relate to a method of wireless communication performed by a first UE. The method may include receiving, from a network node via an access link, one or more reference signals associated with a monitoring procedure for an AI/ML model of the first UE. The method may include performing the monitoring procedure for the AI/ML model of the first UE based at least in part on the one or more reference signals. The method may include transmitting, to a second UE via a sidelink, monitoring information associated with the AI/ML model of the first UE based at least in part on performing the monitoring procedure for the AI/ML model of the first UE.

Other aspects provide: an apparatus operable, configured, or otherwise adapted to perform any one or more of the aforementioned methods and/or those described herein with reference to and as illustrated by the drawings and specification; a non-transitory, computer-readable medium comprising computer-executable instructions that, when executed by a processor of an apparatus, cause the apparatus to perform the aforementioned methods and/or those described herein with reference to and as illustrated by the drawings and specification; a computer program product embodied on a computer-readable storage medium comprising code for performing the aforementioned methods and/or those described herein with reference to and as illustrated by the drawings and specification; and/or an apparatus comprising means for performing the aforementioned methods and/or those described herein with reference to and as illustrated by the drawings and specification. By way of example, an apparatus may comprise a processing system, a device with a processing system, or processing systems cooperating over one or more networks.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 depicts an example of a wireless communications network, in accordance with the present disclosure.

FIG. 2 depicts aspects of an example base station and user equipment (UE), in accordance with the present disclosure.

FIG. 3 depicts an example disaggregated base station architecture, in accordance with the present disclosure.

FIGS. 4A, 4B, 4C, and 4D depict aspects of data structures for a wireless communications network, such as wireless communications network of FIG. 1, in accordance with the present disclosure.

FIG. 5 is a diagram illustrating an example of sidelink communications, in accordance with the present disclosure.

FIG. 6 is a diagram illustrating an example of sidelink communications and access link communications, in accordance with the present disclosure.

FIG. 7 is a diagram illustrating examples of channel state information reference signal beam management procedures, in accordance with the present disclosure.

FIG. 8 is a diagram illustrating an example architecture of a functional framework for radio access network intelligence enabled by data collection, in accordance with the present disclosure.

FIG. 9 is a diagram illustrating an example of beam management artificial intelligence (AI)/machine learning (ML) models, in accordance with the present disclosure.

FIG. 10 is a diagram of an example associated with sidelink-assisted AI/ML model monitoring, in accordance with the present disclosure.

FIG. 11 shows a method for wireless communications by a first UE, in accordance with the present disclosure.

FIG. 12 shows another method for wireless communications by a first UE, in accordance with the present disclosure.

FIG. 13 is a diagram illustrating an example of an implementation of code and circuitry for a communications device, in accordance with the present disclosure.

FIG. 14 is another diagram illustrating an example of an implementation of code and circuitry for a communications device, in accordance with the present disclosure.

### DETAILED DESCRIPTION

Aspects of the present disclosure provide apparatuses, methods, processing systems, and computer-readable mediums for using sidelink communication to facilitate and/or enhance an artificial intelligence (AI)/machine learning (ML) model monitoring procedure at a user equipment (UE).

In some wireless communication systems, a network node and/or a UE may use an AI/ML model for a purpose of performing a beam prediction procedure, performing a beam selection procedure, performing a beam failure detection (BFD) procedure, performing a beam failure recovery (BFR) procedure, performing another beam management procedure, and/or for another purpose. In some cases, one or more network devices may monitor a performance of an AI/ML model in order to determine whether the model is performing as intended and/or whether a different model or beam management procedure should be implemented instead, which is sometimes referred to as an AI/ML model monitoring procedure. In some cases, an AI/ML model monitoring procedure may require high signaling overhead and/or may be resource-intensive. This is because, in order to perform the monitoring procedure, a network node may need to transmit, to a UE, dedicated downlink reference signals (sometimes referred to as auxiliary reference signals). More particularly, a UE may receive the dedicated downlink reference signals, compute one or more key performance indicators (KPIs) (sometimes referred to as monitoring KPIs) based at least in part on measurement of the dedicated downlink reference signals, and make a monitoring decision regarding the AI/ML model based at least in part on monitoring KPIs or similar information. For wireless communication systems involving many UEs using an AI/ML model, a network node may need to transmit multiple instances of the dedicated downlink reference signals (e.g., multiple sets of periodically reoccurring dedicated downlink reference signals, one for each UE using an AI/ML model), resulting in high signaling overhead, crowded communication channels, decreased network throughput, increased network latency, and overall inefficient usage of network resources.

Some techniques and apparatuses described herein enable reduced signaling overhead associated with an AI/ML model monitoring procedure by enabling communication of AI/ML monitoring information between multiple UEs using a sidelink. Communicating monitoring information over a sidelink may reduce an amount of dedicated downlink reference signals that would otherwise be required for a UE to perform an AI/ML model monitoring procedure or similar operation. In some aspects, a network node may indicate to a UE using an AI/ML model that a similar UE (e.g., a UE associated with a same make of UE or model UE) is also using an AI/ML model. For example, the network node may indicate that the two UEs are associated with a same type of AI/ML model (e.g., the network node may indicate that the UEs are using an AI/ML model associated with a same model identifier (ID)), which may or may not share AI/ML model parameters (e.g., in some aspects, the UEs may have updated their respective AI/ML models differently). Accordingly, the UEs may communicate monitoring information associated with the AI/ML model over a sidelink, such as for a purpose of reducing dedicated reference signals transmissions to at least one UE. For example, a first UE may receive dedicated reference signals from the network node and perform a monitoring procedure associated with an AI/ML model of the first UE, such as by performing measurements on the dedicated reference signals and comparing the measurements to predicted measurements outputted by the AI/ML model. The first UE may transmit monitoring information associated with a monitoring procedure to a second UE using a same AI/ML model. The second UE may thus perform a monitoring procedure associated with an AI/ML model of the second UE based at least in part on the monitoring information received from the first UE, without requiring dedicated reference signals from the network node and/or based at least in part on a reduced number of dedicated reference signals from the network node.

Based at least in part on multiple UEs communicating monitoring information over a sidelink in this manner, dedicated reference signals transmitted by a network node to one or more UEs for purposes of performing a monitoring procedure associated with an AI/ML model may be reduced. Reducing the amount of dedicated reference signals transmitted by the network node may result in less cluttered communication channels and thus increased throughput, reduced latency, and overall more efficient usage of network resources. Moreover, by sharing monitoring information across a sidelink, one or more UEs may be provided with additional sources of information associated with a performance of an AI/ML model, thereby enabling more-informed AI/ML model monitoring decisions. This may enable more accurate AI/ML models (e.g., more accurate AI/ML models associated with a beam management procedure) and thus more robust communication channels between one or more UEs and a network node, resulting in reduced communication errors and thus decreased power, computing, and network resource consumption that would otherwise be required to correct communication errors.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

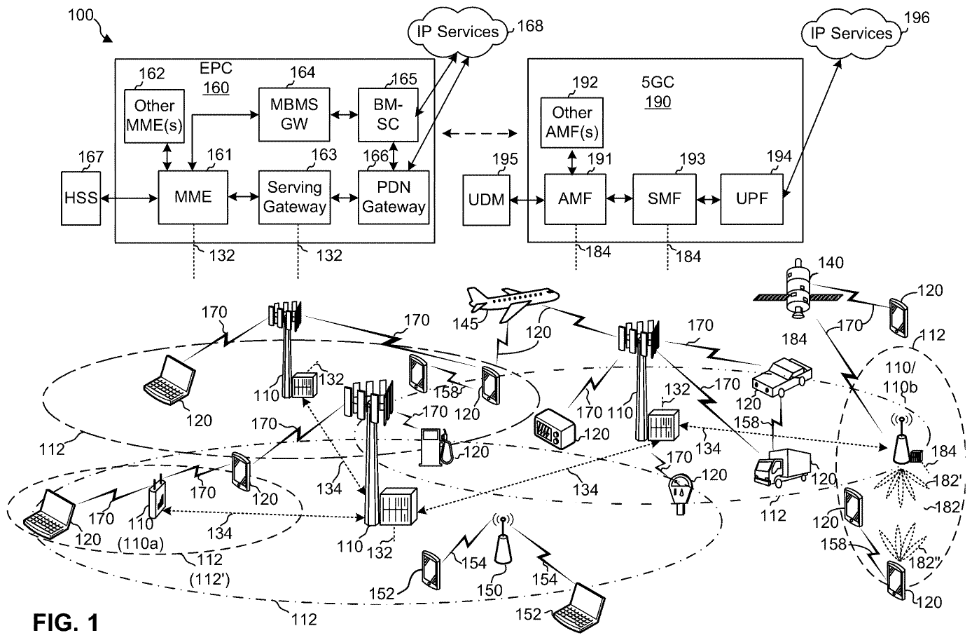

FIG. 1 depicts an example of a wireless communications network 100, in accordance with the present disclosure.

Generally, wireless communications network 100 includes various network entities (alternatively, network elements or network nodes). A network entity is generally a communications device and/or a communications function performed by a communications device (e.g., a UE, a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 110), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 110, UEs 120, and one or more core networks, such as an Evolved Packet Core (EPC) 160 and 5G Core (5GC) 190, which interoperate to provide communications services over various communications links, including wired and wireless links.

FIG. 1 depicts various example UEs 120, which may include a cellular phone, a smart phone, a session initiation protocol (SIP) phone, a laptop, a personal digital assistant (PDA), a satellite radio, a global positioning system (GPS), a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an internet of things (IoT) device, an always on (AON) device, an edge processing device, or another similar device. A UE 120 may also be referred to as a mobile device, a wireless device, a wireless communication device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, or a handset, among other examples.

BSs 110 may wirelessly communicate with (e.g., transmit signals to or receive signals from) UEs 120 via communications links 170. The communications links 170 between BSs 110 and UEs 120 may carry uplink (UL) (also referred to as reverse link) transmissions from a UE 120 to a BS 110 and/or downlink (DL) (also referred to as forward link) transmissions from a BS 110 to a UE 120. The communications links 170 may use multiple-input and multiple-output (MIMO) antenna technology, including spatial multiplexing, beamforming, and/or transmit diversity in various aspects.

A BS 110 may include, for example, a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point, and/or others. A BS 110 may provide communications coverage for a respective geographic coverage area 112, which may sometimes be referred to as a cell, and which may overlap in some cases (e.g., a small cell provided by a BS 110a may have a coverage area 112′ that overlaps the coverage area 112 of a macro cell). A BS 110 may, for example, provide communications coverage for a macro cell (covering a relatively large geographic area), a pico cell (covering a relatively smaller geographic area, such as a sports stadium), a femto cell (covering a relatively smaller geographic area (e.g., a home)), and/or other types of cells.

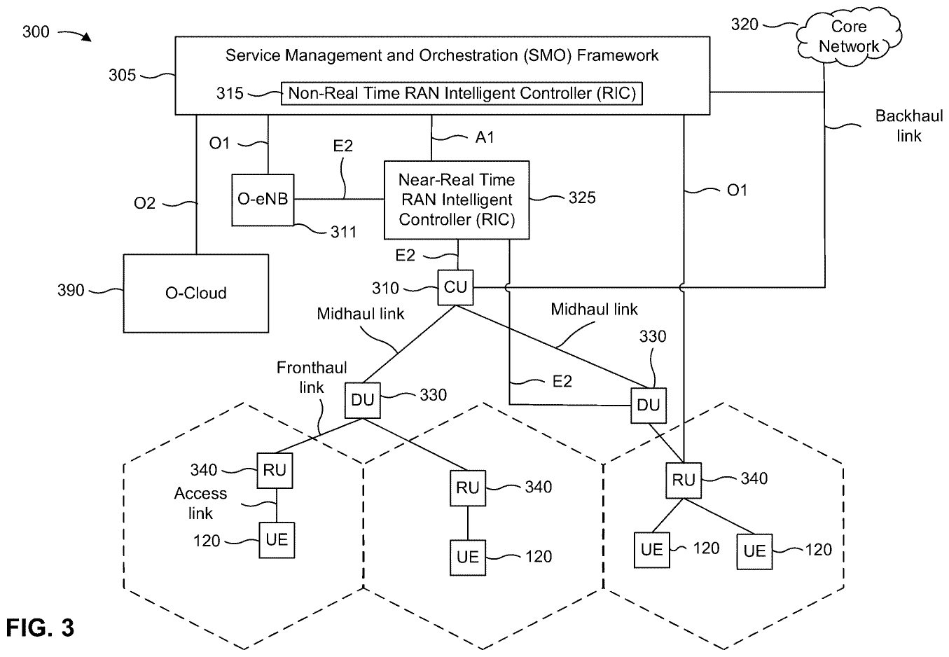

While BSs 110 are depicted in various aspects as unitary communications devices, BSs 110 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a BS (e.g., BS 110) may include components that are located at a single physical location or components located at various physical locations. In examples in which a BS includes components that are located at various physical locations, the various components may each perform functions such that, collectively, the various components achieve functionality that is similar to a BS that is located at a single physical location. In some aspects, a BS including components that are located at various physical locations may be referred to as having a disaggregated radio access network architecture, such as an Open RAN (O-RAN) architecture or a Virtualized RAN (VRAN) architecture. FIG. 3 depicts and describes an example disaggregated BS architecture.

Different BSs 110 within wireless communications network 100 may also be configured to support different radio access technologies, such as 3G, 4G, and/or 5G, among other examples. For example, BSs 110 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 110 configured for 5G (e.g., 5G NR or Next Generation RAN (NG-RAN)) may interface with 5GC 190 through second backhaul links 184. BSs 110 may communicate directly or indirectly (e.g., through the EPC 160 or 5GC 190) with each other over third backhaul links 134 (e.g., X2 interfaces), which may be wired or wireless.

Wireless communications network 100 may subdivide the electromagnetic spectrum into various classes, bands, channels, or other features. In some aspects, the subdivision is based on wavelength and frequency, where frequency may also be referred to as a carrier, a subcarrier, a frequency channel, a tone, or a subband. For example, the 3rd Generation Partnership Project (3GPP) currently defines Frequency Range 1 (FR1) as including 410 megahertz (MHz)-7125 MHz, which is often referred to (interchangeably) as “Sub-6 gigahertz (GHz)”. Similarly, 3GPP currently defines Frequency Range 2 (FR2) as including 24,250 MHz-52,600 MHz, which is sometimes referred to (interchangeably) as a “millimeter wave” (“mmW” or “mm Wave”). A base station configured to communicate using mm Wave or near mm Wave radio frequency bands (e.g., a mmWave base station such as BS 110b) may utilize beamforming (e.g., as shown by 182) with a UE (e.g., 120) to improve path loss and range.

The communications links 170 between BSs 110 and, for example, UEs 120, may be through one or more carriers, which may have different bandwidths (e.g., 5 MHz, 10 MHZ, 15 MHz, 20 MHZ, 100 MHZ, 400 MHZ, and/or other bandwidths), and which may be aggregated in various aspects. Carriers may or may not be adjacent to each other. In some examples, allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 110b in FIG. 1) may utilize beamforming with a UE 120 to improve path loss and range, as shown at 182. For example, BS 110b and the UE 120 may each include a plurality of antennas, such as antenna elements, antenna panels, and/or antenna arrays to facilitate the beamforming. In some cases, BS 110b may transmit a beamformed signal to UE 120 in one or more transmit directions 182′. UE 120 may receive the beamformed signal from the BS 110b in one or more receive directions 182″. UE 120 may also transmit a beamformed signal to the BS 110b in one or more transmit directions 182″. BS 110b may also receive the beamformed signal from UE 120 in one or more receive directions 182′. BS 110b and UE 120 may then perform beam training to determine the best receive and transmit directions for each of BS 110b and UE 120. Notably, the transmit and receive directions for BS 110b may or may not be the same. Similarly, the transmit and receive directions for UE 120 may or may not be the same.

Wireless communications network 100 further includes a Wi-Fi access point (AP) 150 in communication with Wi-Fi stations (STAs) 152 via communications links 154 in, for example, a 2.4 GHz and/or 5 GHz unlicensed frequency spectrum.

Certain UEs 120 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 161, other MMEs 162, a Serving Gateway 163, a Multimedia Broadcast Multicast Service (MBMS) Gateway 164, a Broadcast Multicast Service Center (BM-SC) 165, and/or a Packet Data Network (PDN) Gateway 166, such as in the depicted example. MME 161 may be in communication with a Home Subscriber Server (HSS) 167. MME 161 is a control node that processes the signaling between the UEs 120 and the EPC 160. Generally, MME 161 provides bearer and connection management.

Generally, user Internet protocol (IP) packets are transferred through Serving Gateway 163, which is connected to PDN Gateway 166. PDN Gateway 166 provides UE IP address allocation as well as other functions. PDN Gateway 166 and the BM-SC 165 are connected to IP Services 168, which may include, for example, the Internet, an intranet, an IP Multimedia Subsystem (IMS), a Packet Switched (PS) streaming service, and/or other IP services.

BM-SC 165 may provide functions for MBMS user service provisioning and delivery. BM-SC 165 may serve as an entry point for content provider MBMS transmission, may be used to authorize and initiate MBMS Bearer Services within a public land mobile network (PLMN), and/or may be used to schedule MBMS transmissions. MBMS Gateway 164 may distribute MBMS traffic to the BSs 110 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 191, other AMFs 192, a Session Management Function (SMF) 193, and a User Plane Function (UPF) 194. AMF 191 may be in communication with Unified Data Management (UDM) 195.

AMF 191 is a control node that processes signaling between UEs 120 and 5GC 190. AMF 191 provides, for example, quality of service (QOS) flow and session management.

IP packets are transferred through UPF 194, which is connected to the IP Services 196, and which provides UE IP address allocation as well as other functions for 5GC 190. IP Services 196 may include, for example, the Internet, an intranet, an IMS, a PS streaming service, and/or other IP services.

In various aspects, a network entity or network node can be implemented as an aggregated base station, a disaggregated base station, a component of a base station, an integrated access and backhaul (IAB) node, a relay node, a sidelink node, a transmission reception point (TRP), or a combination thereof, to name a few examples.

As indicated above, FIG. 1 is provided as an example. Other examples may differ from what is described with regard to FIG. 1.

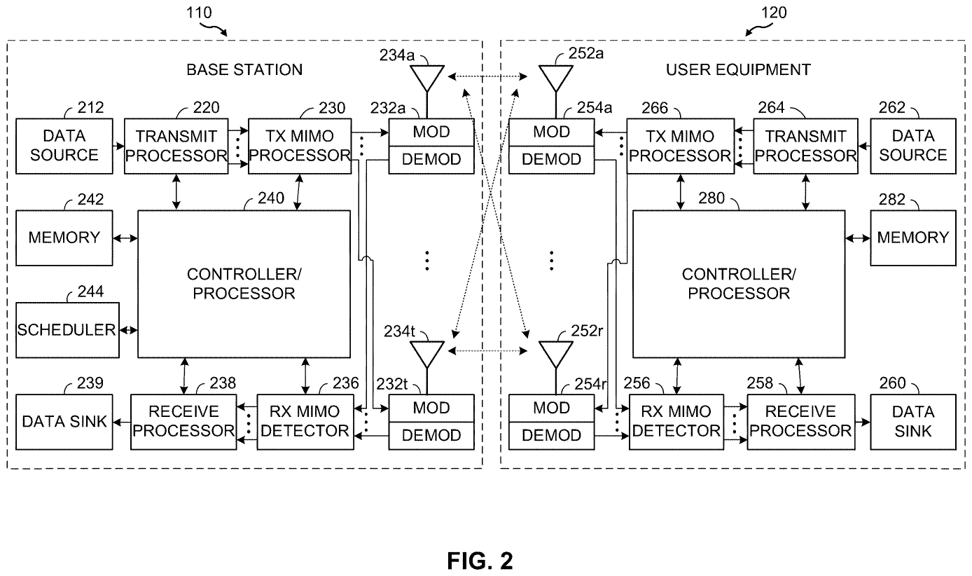

FIG. 2 depicts aspects of an example BS 110 and UE 120, in accordance with the present disclosure.

Generally, BS 110 includes various processors (e.g., 220, 230, 238, and 240), antennas 234a-t (collectively 234), transceivers 232a-t (collectively 232), which include modulators and demodulators, and other aspects, which enable wireless transmission of data (e.g., data source 212) and wireless reception of data (e.g., data sink 239). For example, BS 110 may send and receive data between BS 110 and UE 120. BS 110 includes controller/processor 240, which may be configured to implement various functions described herein related to wireless communications.

Generally, UE 120 includes various processors (e.g., 258, 264, 266, and 280), antennas 252a-r (collectively 252), transceivers 254a-r (collectively 254), which include modulators and demodulators, and other aspects, which enable wireless transmission of data (e.g., retrieved from data source 262) and wireless reception of data (e.g., provided to data sink 260). UE 120 includes controller/processor 280, which may be configured to implement various functions described herein related to wireless communications.

For an example downlink transmission, BS 110 includes a transmit processor 220 that may receive data from a data source 212 and control information from a controller/processor 240. The control information may be for the physical broadcast channel (PBCH), the physical control format indicator channel (PCFICH), the physical hybrid automatic repeat request (HARQ) indicator channel (PHICH), the physical downlink control channel (PDCCH), the group common PDCCH (GC PDCCH), and/or other channels. The data may be for the physical downlink shared channel (PDSCH), in some examples.

Transmit processor 220 may process (e.g., encode and symbol map) the data and control information to obtain data symbols and control symbols, respectively.

Transmit processor 220 may also generate reference symbols, such as for the primary synchronization signal (PSS), the secondary synchronization signal (SSS), the PBCH demodulation reference signal (DMRS), or the channel state information reference signal (CSI-RS).

Transmit (TX) MIMO processor 230 may perform spatial processing (e.g., precoding) on the data symbols, the control symbols, and/or the reference symbols, if applicable, and may provide output symbol streams to the modulators (MODs) in transceivers 232a-232t. Each modulator in transceivers 232a-232t may process a respective output symbol stream to obtain an output sample stream. Each modulator may further process (e.g., convert to analog, amplify, filter, and upconvert) the output sample stream to obtain a downlink signal. Downlink signals from the modulators in transceivers 232a-232t may be transmitted via the antennas 234a-234t, respectively.

UE 120 includes antennas 252a-252r that may receive the downlink signals from the BS 110 and may provide received signals to the demodulators (DEMODs) in transceivers 254a-254r, respectively. Each demodulator in transceivers 254a-254r may condition (e.g., filter, amplify, downconvert, and digitize) a respective received signal to obtain input samples. Each demodulator may further process the input samples to obtain received symbols.

MIMO detector 256 may obtain received symbols from all the demodulators in transceivers 254a-254r, perform MIMO detection on the received symbols if applicable, and provide detected symbols. Receive processor 258 may process (e.g., demodulate, deinterleave, and decode) the detected symbols, provide decoded data for the UE 120 to a data sink 260, and provide decoded control information to a controller/processor 280.

For an example uplink transmission, UE 120 further includes a transmit processor 264 that may receive and process data (e.g., for the physical uplink shared channel (PUSCHI)) from a data source 262 and control information (e.g., for the physical uplink control channel (PUCCH)) from the controller/processor 280. Transmit processor 264 may also generate reference symbols for a reference signal (e.g., for the sounding reference signal (SRS)). The symbols from the transmit processor 264 may be precoded by a TX MIMO processor 266 if applicable, further processed by the modulators in transceivers 254a-254r (e.g., for single-carrier frequency division multiplexing (SC-FDM)), and transmitted to BS 110.

At BS 110, the uplink signals from UE 120 may be received by antennas 234a-234t, processed by the demodulators in transceivers 232a-232t, detected by a MIMO detector 236 if applicable, and further processed by a receive processor 238 to obtain decoded data and control information sent by UE 120. Receive processor 238 may provide the decoded data to a data sink 239 and the decoded control information to the controller/processor 240. Memories 242 and 282 may store data and program codes (e.g., processor-executable instructions, computer-executable instructions) for BS 110 and UE 120, respectively. Scheduler 244 may schedule UEs for data transmission on the downlink and/or uplink.

In various aspects, BS 110 may be described as transmitting and receiving various types of data associated with the methods described herein. In these contexts, “transmitting” may refer to various mechanisms of outputting data, such as outputting data from data source 212, scheduler 244, memory 242, transmit processor 220, controller/processor 240, TX MIMO processor 230, transceivers 232a-t, antenna 234a-t, and/or other aspects described herein. Similarly, “receiving” may refer to various mechanisms of obtaining data, such as obtaining data from antennas 234a-t, transceivers 232a-t, receive (RX) MIMO detector 236, controller/processor 240, receive processor 238, scheduler 244, memory 242, a network interface, and/or other aspects described herein.

In various aspects, UE 120 may likewise be described as transmitting and receiving various types of data associated with the methods described herein. In these contexts, “transmitting” may refer to various mechanisms of outputting data, such as outputting data from data source 262, memory 282, transmit processor 264, controller/processor 280, TX MIMO processor 266, transceivers 254a-t, antenna 252a-t, and/or other aspects described herein. Similarly, “receiving” may refer to various mechanisms of obtaining data, such as obtaining data from antennas 252a-t, transceivers 254a-t, RX MIMO detector 256, controller/processor 280, receive processor 258, memory 282, and/or other aspects described herein.

In some aspects, a processor may be configured to perform various operations, such as those associated with the methods described herein, and transmit (output) data to or receive (obtain) data from another interface that is configured to transmit or receive, respectively, the data.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an AP, a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

FIG. 3 depicts an example disaggregated base station 300 architecture, in accordance with the present disclosure. The disaggregated base station 300 architecture may include one or more CUs 310 that can communicate directly with a core network 320 via a backhaul link, or indirectly with the core network 320 through one or more disaggregated base station units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as an F1 interface. The DUs 330 may communicate with one or more RUs 340 via respective fronthaul links. The RUs 340 may communicate with respective UEs 120 via one or more radio frequency (RF) access links. In some implementations, the UE 120 may be simultaneously served by multiple RUs 340.

Each of the units (e.g., the CUS 310, the DUs 330, the RUs 340, as well as the Near-RT RICs 325, the Non-RT RICs 315 and the SMO Framework 305) may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., Central Unit-User Plane (CU-UP)), control plane functionality (e.g., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by 3GPP. In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over-the-air (OTA) communications with one or more UEs 120. In some implementations, real-time and non-real-time aspects of control and user plane communications with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, AI/ML workflows including model training and updates, or policy-based guidance of applications/features in the Near-RT RIC 325. The Non-RT RIC 315 may be coupled to or communicate with (such as via an Al interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

As indicated above, FIG. 3 is provided as an example. Other examples may differ from what is described with regard to FIG. 3.

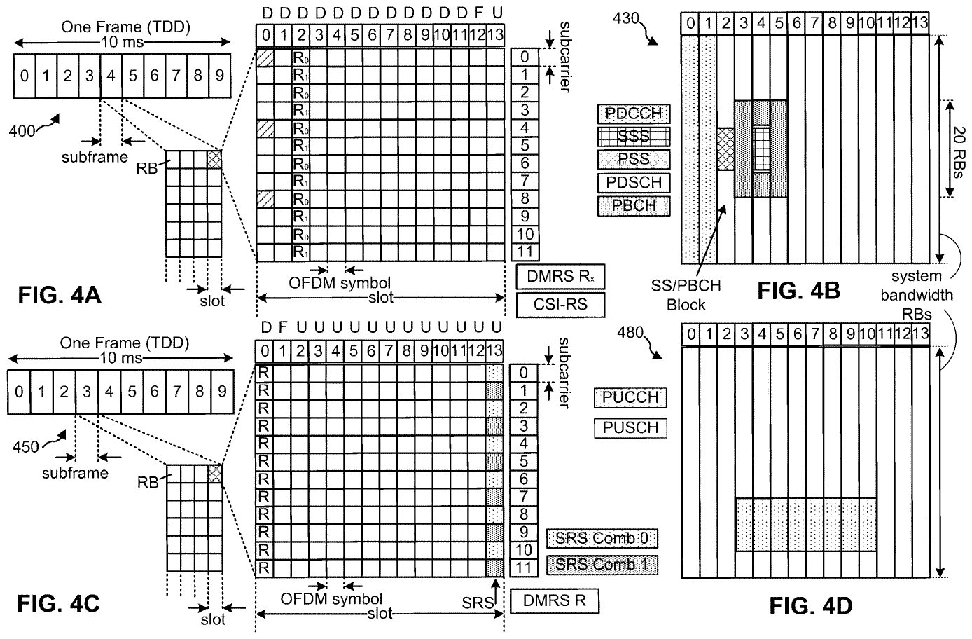

FIGS. 4A, 4B, 4C, and 4D depict aspects of data structures for a wireless communications network, such as wireless communications network 100 of FIG. 1, in accordance with the present disclosure. FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and SC-FDM partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be TDD, in which, for a particular set of subcarriers, subframes within the set of subcarriers are dedicated for both DL and UL.

In FIGS. 4A and 4C, the wireless communications frame structure is TDD where D is DL, U is UL, and F is flexible for use between DL/UL. UEs may be configured with a slot format through a received slot format indicator (SFI) (dynamically through DL control information (DCI), or semi-statically/statically through RRC signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 24 slots/subframe. The subcarrier spacing and symbol length/duration are a function of the numerology. The subcarrier spacing may be equal to 2^{μ}×15 kHz, where u is the numerology index, which may be selected from values 0 to 5. Accordingly, the numerology p=0 has a subcarrier spacing of 15 kHz and the numerology μ=5 has a subcarrier spacing of 480 kHz. Other numerologies and subcarrier spacings may be used. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RSS) for a UE (e.g., UE 120). The RSs may include DMRSs and/or CSI-RSs for channel estimation at the UE. The RSs may also include beam measurement RSs (BRSs), beam refinement RSs (BRRSs), and/or phase tracking RSs (PT-RSs).

FIG. 4B illustrates an example of various DL channels within a subframe of a frame. The PDCCH carries DCI within one or more control channel elements (CCEs), each CCE including, for example, nine RE groups (REGs), each REG including, for example, four consecutive REs in an OFDM symbol.

A PSS may be within symbol 2 of particular subframes of a frame. The PSS is used by a UE (e.g., UE 120) to determine subframe/symbol timing and a physical layer identity.

An SSS may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRSs. The PBCH, which carries a master information block (MIB), may be logically grouped with the PSS and SSS to form a synchronization signal (SS)/PBCH block (SSB). The MIB provides a number of RBs in the system bandwidth and a system frame number (SFN). The PDSCH carries user data, broadcast system information not transmitted through the PBCH such as system information blocks (SIBs), and/or paging messages.

As illustrated in FIG. 4C, some of the REs carry DMRSs (indicated as R for one particular configuration, but other DMRS configurations are possible) for channel estimation at the base station. The UE may transmit DMRSs for the PUCCH and DMRSs for the PUSCH. The PUSCH DMRSs may be transmitted, for example, in the first one or two symbols of the PUSCH. The PUCCH DMRSs may be transmitted in different configurations depending on whether short or long PUCCHs are transmitted and depending on the particular PUCCH format used. UE 120 may transmit SRSs. The SRSs may be transmitted, for example, in the last symbol of a subframe. The SRSs may have a comb structure, and a UE may transmit SRSs on one of the combs. The SRSs may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ acknowledgement or negative acknowledgement (ACK/NACK) feedback. The PUSCH carries data, and may additionally be used to carry a buffer status report (BSR), a power headroom report (PHR), and/or UCI.

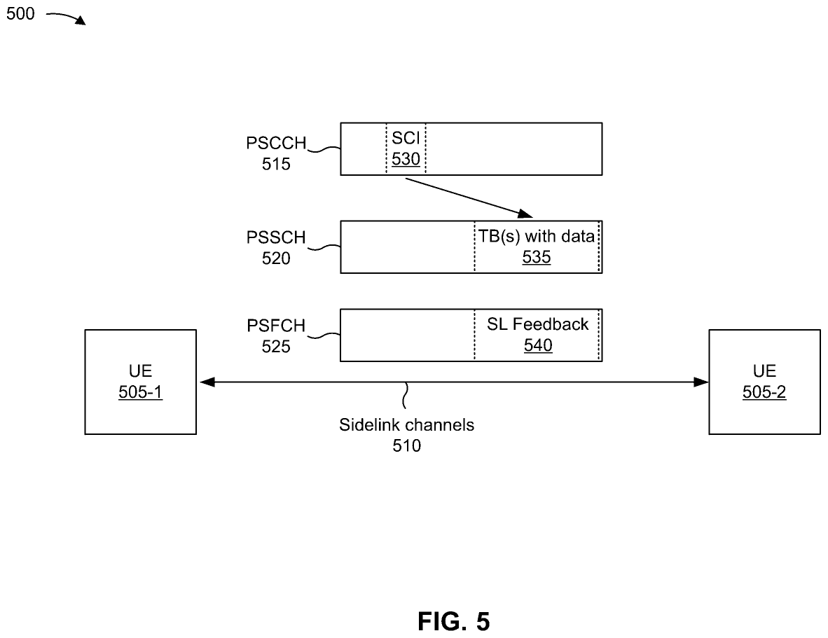

FIG. 5 is a diagram illustrating an example 500 of sidelink communications, in accordance with the present disclosure.

As shown in FIG. 5, a first UE 505-1 may communicate with a second UE 505-2 (and one or more other UEs 505) via one or more sidelink channels 510. The UEs 505-1 and 505-2 may communicate using the one or more sidelink channels 510 for peer-to-peer (P2P) communications, D2D communications, vehicle-to-everything (V2X) communications (e.g., which may include vehicle-to-vehicle (V2V) communications, vehicle-to-infrastructure (V2I) communications, and/or vehicle-to-pedestrian (V2P) communications) and/or mesh networking. In some aspects, the UEs 505 (e.g., UE 505-1 and/or UE 505-2) may correspond to one or more other UEs described elsewhere herein, such as UE 120. In some aspects, the one or more sidelink channels 510 may use a PC5 interface and/or may operate in a high frequency band (e.g., the 5.9 GHz band). Additionally, or alternatively, the UEs 505 may synchronize timing of transmission time intervals (TTIs) (e.g., frames, subframes, slots, or symbols) using global navigation satellite system (GNSS) timing.

As further shown in FIG. 5, the one or more sidelink channels 510 may include a PSCCH 515, a PSSCH 520, and/or a PSFCH 525, among other sidelink channels (e.g., a PSBCH). The PSCCH 515 may be used to communicate control information, similar to a PDCCH and/or a PUCCH used for cellular communications with a network node (e.g., a BS 110, a CU, a DU, an RU, and/or a similar network entity) via an access link or an access channel. The PSSCH 520 may be used to communicate data, similar to a PDSCH and/or a PUSCH used for cellular communications with a network node via an access link or an access channel. For example, the PSCCH 515 may carry sidelink control information (SCI) 530, which may indicate various control information used for sidelink communications, such as one or more resources (e.g., time resources, frequency resources, and/or spatial resources) where a transport block (TB) 535 may be carried on the PSSCH 520. The TB 535 may include data. The PSFCH 525 may be used to communicate sidelink feedback 540, such as HARQ feedback (e.g., ACK/NACK information), transmit power control (TPC), and/or a scheduling request (SR). In some examples, one or more sidelink channels may be used to transmit reference signals between the UE 505-1 and the UE 505-2. For example, one or more sidelink channels may be used to transmit one or more DMRSs for PSCCH, DMRSs for PSSCH, DMRSs for PSBCH, CSI-RSs, sidelink PSSs (S-PSSs), sidelink SSS (S-SSSs), and/or phase-tracking reference signals (PTRSs) (e.g., for FR2).

Although shown on the PSCCH 515, in some aspects, the SCI 530 may include multiple communications in different stages, such as a first stage SCI (SCI-1) and a second stage SCI (SCI-2). The SCI-1 may be transmitted on the PSCCH 515. The SCI-2 may be transmitted on the PSSCH 520. The SCI-1 may include, for example, an indication of one or more resources (e.g., time resources, frequency resources, and/or spatial resources) on the PSSCH 520, information for decoding sidelink communications on the PSSCH, a QoS priority value, a resource reservation period, a PSSCH DMRS pattern, an SCI format for the SCI-2, a beta offset for the SCI-2, a quantity of PSSCH DMRS ports, and/or a modulation and coding scheme (MCS). The SCI-2 may include information associated with data transmissions on the PSSCH 520, such as a HARQ process ID, a new data indicator (NDI), a source identifier, a destination identifier, and/or a channel state information (CSI) report trigger.

In some aspects, the one or more sidelink channels 510 may use resource pools. For example, a scheduling assignment (e.g., included in SCI 530) may be transmitted in sub-channels using specific RBs across time. In some aspects, data transmissions (e.g., on the PSSCH 520) associated with a scheduling assignment may occupy adjacent RBs in the same subframe as the scheduling assignment (e.g., using frequency division multiplexing). In some aspects, a scheduling assignment and associated data transmissions are not transmitted on adjacent RBs.

In some aspects, a UE 505 may operate using a sidelink transmission mode (e.g., Mode 1) where resource selection and/or scheduling is performed by a network node (e.g., a BS 110, a CU, or a DU). For example, the UE 505 may receive a grant (e.g., in DCI or in an RRC message, such as for configured grants) from the network node (e.g., directly or via one or more network nodes) for sidelink channel access and/or scheduling. In some aspects, a UE 505 may operate using a transmission mode (e.g., Mode 2) where resource selection and/or scheduling is performed by the UE 505 (e.g., rather than a network node). In some aspects, the UE 505 may perform resource selection and/or scheduling by sensing channel availability for transmissions. For example, the UE 505 may measure a received signal strength indicator (RSSI) parameter (e.g., a sidelink-RSSI (S-RSSI) parameter) associated with various sidelink channels, may measure a reference signal received power (RSRP) parameter (e.g., a PSSCH-RSRP parameter) associated with various sidelink channels, and/or may measure a reference signal received quality (RSRQ) parameter (e.g., a PSSCH-RSRQ parameter) associated with various sidelink channels, and may select a channel for transmission of a sidelink communication based at least in part on the measurement(s).

Additionally, or alternatively, the UE 505 may perform resource selection and/or scheduling using SCI 530 received in the PSCCH 515, which may indicate occupied resources and/or channel parameters. Additionally, or alternatively, the UE 505 may perform resource selection and/or scheduling by determining a channel busy ratio (CBR) associated with various sidelink channels, which may be used for rate control (e.g., by indicating a maximum number of resource blocks that the UE 505 can use for a particular set of subframes).

In the transmission mode where resource selection and/or scheduling is performed by a UE 505, the UE 505 may generate sidelink grants, and may transmit the grants in SCI 530. A sidelink grant may indicate, for example, one or more parameters (e.g., transmission parameters) to be used for an upcoming sidelink transmission, such as one or more resource blocks to be used for the upcoming sidelink transmission on the PSSCH 520 (e.g., for TBs 535), one or more subframes to be used for the upcoming sidelink transmission, and/or an MCS to be used for the upcoming sidelink transmission. In some aspects, a UE 505 may generate a sidelink grant that indicates one or more parameters for semi-persistent scheduling (SPS), such as a periodicity of a sidelink transmission. Additionally, or alternatively, the UE 505 may generate a sidelink grant for event-driven scheduling, such as for an on-demand sidelink message.

As indicated above, FIG. 5 is provided as an example. Other examples may differ from what is described with respect to FIG. 5.

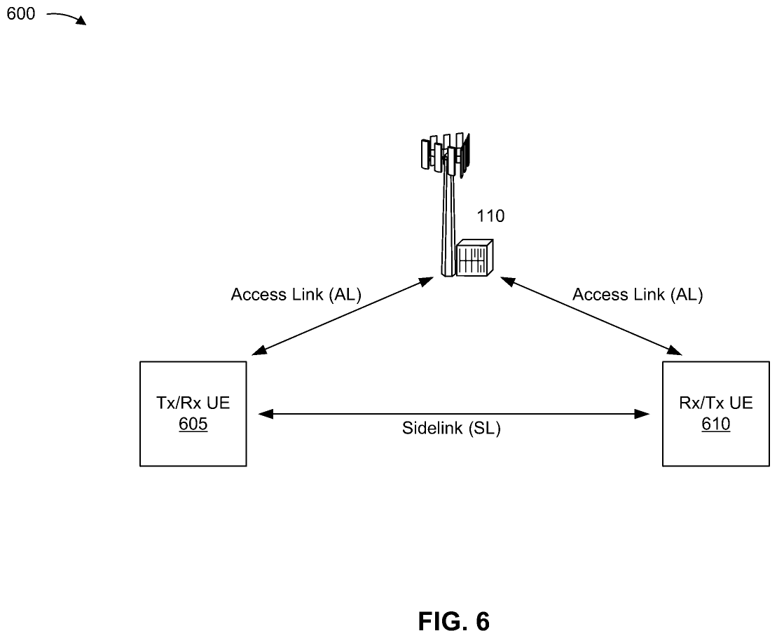

FIG. 6 is a diagram illustrating an example 600 of sidelink communications and access link communications, in accordance with the present disclosure.

As shown in FIG. 6, a transmitter (Tx)/receiver (Rx) UE 605 and an Rx/Tx UE 610 may communicate with one another via a sidelink, as described above in connection with FIG. 5. As further shown, in some sidelink modes, a BS 110 or similar network node (e.g., a CU, a DU, an RU, and/or a similar network entity) may communicate with the Tx/Rx UE 605 (e.g., directly or via one or more network nodes), such as via a first access link. Additionally, or alternatively, in some sidelink modes, the BS 110 may communicate with the Rx/Tx UE 610 (e.g., directly or via one or more network nodes), such as via a first access link. The Tx/Rx UE 605 and/or the Rx/Tx UE 610 may correspond to one or more UEs described elsewhere herein, such as the UE 120 of FIG. 1. Thus, a direct link between UEs 120 (e.g., via a PC5 interface) may be referred to as a sidelink, and a direct link between a BS 110 and a UE 120 (e.g., via a Uu interface) may be referred to as an access link. Sidelink communications may be transmitted via the sidelink, and access link communications may be transmitted via the access link.

An access link communication may be either a downlink communication (from a BS 110 to a UE 120) or an uplink communication (from a UE 120 to a BS 110).

As indicated above, FIG. 6 is provided as an example. Other examples may differ from what is described with respect to FIG. 6.

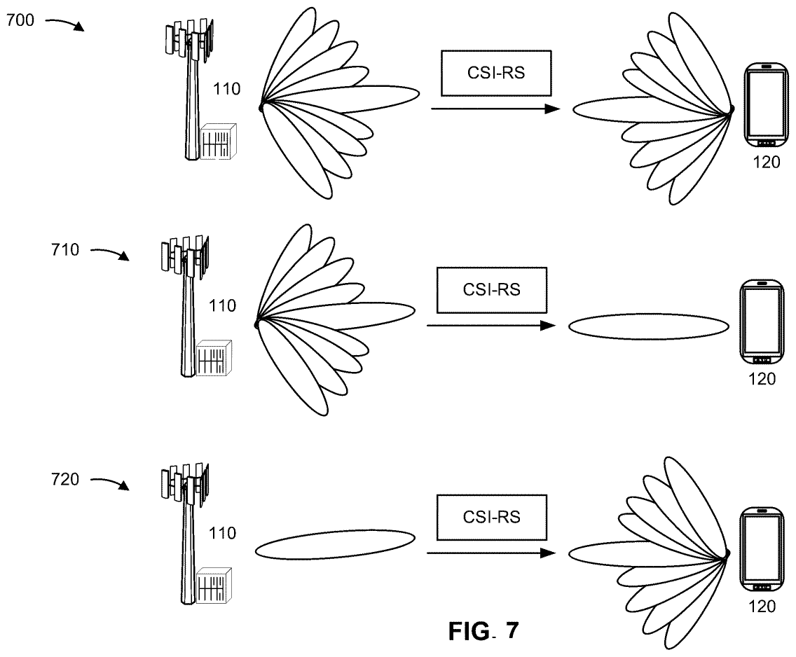

FIG. 7 is a diagram illustrating examples 700, 710, and 720 of CSI-RS beam management procedures, in accordance with the present disclosure. As shown in FIG. 4, examples 700, 710, and 720 include a UE 120 in communication with a BS 110 or a similar network node (e.g., a CU, a DU, an RU, and/or a similar network entity) in a wireless network (e.g., wireless communications network 100). However, the devices shown in FIG. 7 are provided as examples, and the wireless network may support communication and beam management between other devices (e.g., between a UE 120 and a BS 110 or TRP, between a mobile termination node and a control node, between an IAB child node and an IAB parent node, and/or between a scheduled node and a scheduling node). In some aspects, the UE 120 and the BS 110 may be in a connected state (e.g., an RRC connected state).

As shown in FIG. 7, example 700 may include a BS 110 (e.g., one or more network node devices such as an RU, a DU, and/or a CU, among other examples) and a UE 120 communicating to perform beam management using CSI-RSs. Example 700 depicts a first beam management procedure (e.g., P1 CSI-RS beam management). The first beam management procedure may be referred to as a beam selection procedure, an initial beam acquisition procedure, a beam sweeping procedure, a cell search procedure, and/or a beam search procedure. As shown in FIG. 7 and example 700, CSI-RSs may be configured to be transmitted from the BS 110 to the UE 120. The CSI-RSs may be configured to be periodic (e.g., using RRC signaling), semi-persistent (e.g., using MAC control element (MAC-CE) signaling), and/or aperiodic (e.g., using DCI).

The first beam management procedure may include the BS 110 performing beam sweeping over multiple transmit (Tx) beams. The BS 110 may transmit a CSI-RS using each transmit beam for beam management. To enable the UE 120 to perform receive (Rx) beam sweeping, the BS 110 may use a transmit beam to transmit (e.g., with repetitions) each CSI-RS at multiple times within the same RS resource set so that the UE 120 can sweep through receive beams in multiple transmission instances. For example, if the BS 110 has a set of N transmit beams and the UE 120 has a set of M receive beams, the CSI-RS may be transmitted on each of the N transmit beams M times so that the UE 120 may receive M instances of the CSI-RS per transmit beam. In other words, for each transmit beam of the BS 110, the UE 120 may perform beam sweeping through the receive beams of the UE 120. As a result, the first beam management procedure may enable the UE 120 to measure a CSI-RS on different transmit beams using different receive beams to support selection of BS 110 transmit beams/UE 120 receive beam(s) beam pair(s). The UE 120 may report the measurements to the BS 110 to enable the BS 110 to select one or more beam pair(s) for communication between the BS 110 and the UE 120. While example 700 has been described in connection with CSI-RSs, the first beam management process may also use SSBs for beam management in a similar manner as described above.

As shown in FIG. 7, example 710 may include a BS 110 and a UE 120 communicating to perform beam management using CSI-RSs. Example 710 depicts a second beam management procedure (e.g., P2 CSI-RS beam management). The second beam management procedure may be referred to as a beam refinement procedure, a BS beam refinement procedure, a TRP beam refinement procedure, and/or a transmit beam refinement procedure. As shown in FIG. 7 and example 410, CSI-RSs may be configured to be transmitted from the BS 110 to the UE 120. The CSI-RSs may be configured to be aperiodic (e.g., using DCI). The second beam management procedure may include the BS 110 performing beam sweeping over one or more transmit beams. The one or more transmit beams may be a subset of all transmit beams associated with the BS 110 (e.g., determined based at least in part on measurements reported by the UE 120 in connection with the first beam management procedure). The BS 110 may transmit a CSI-RS using each transmit beam of the one or more transmit beams for beam management. The UE 120 may measure each CSI-RS using a single (e.g., a same) receive beam (e.g., determined based at least in part on measurements performed in connection with the first beam management procedure). The second beam management procedure may enable the BS 110 to select a best transmit beam based at least in part on measurements of the CSI-RSs (e.g., measured by the UE 120 using the single receive beam) reported by the UE 120.

As shown in FIG. 7, example 720 depicts a third beam management procedure (e.g., P3 CSI-RS beam management). The third beam management procedure may be referred to as a beam refinement procedure, a UE beam refinement procedure, and/or a receive beam refinement procedure. As shown in FIG. 7 and example 720, one or more CSI-RSs may be configured to be transmitted from the BS 110 to the UE 120. The CSI-RSs may be configured to be aperiodic (e.g., using DCI). The third beam management process may include the BS 110 transmitting the one or more CSI-RSs using a single transmit beam (e.g., determined based at least in part on measurements reported by the UE 120 in connection with the first beam management procedure and/or the second beam management procedure). To enable the UE 120 to perform receive beam sweeping, the BS 110 may use a transmit beam to transmit (e.g., with repetitions) CSI-RS at multiple times within the same RS resource set so that UE 120 can sweep through one or more receive beams in multiple transmission instances. The one or more receive beams may be a subset of all receive beams associated with the UE 120 (e.g., determined based at least in part on measurements performed in connection with the first beam management procedure and/or the second beam management procedure).

The third beam management procedure may enable the BS 110 and/or the UE 120 to select a best receive beam based at least in part on reported measurements received from the UE 120 (e.g., of the CSI-RS of the transmit beam using the one or more receive beams).

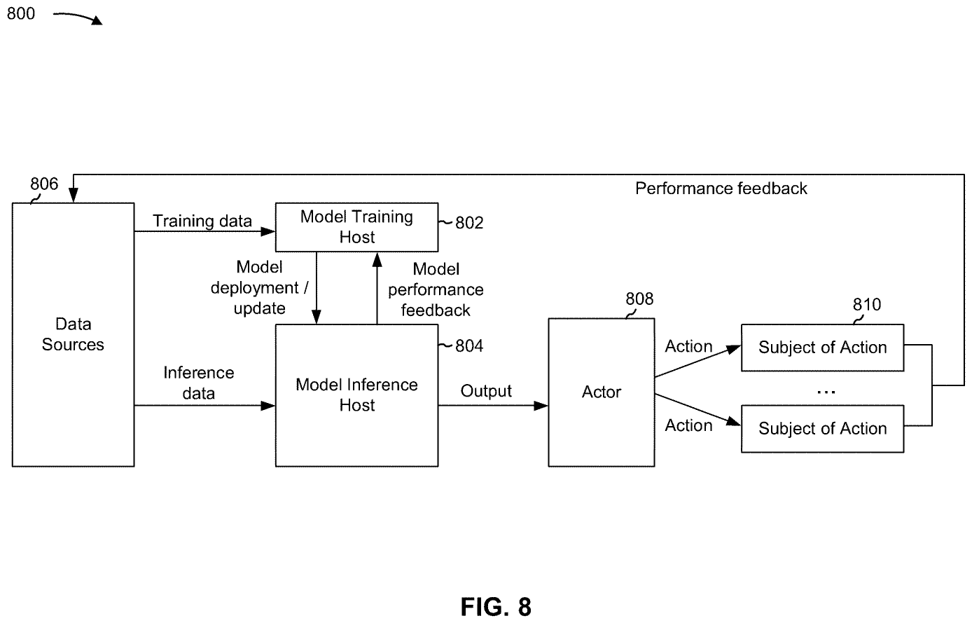

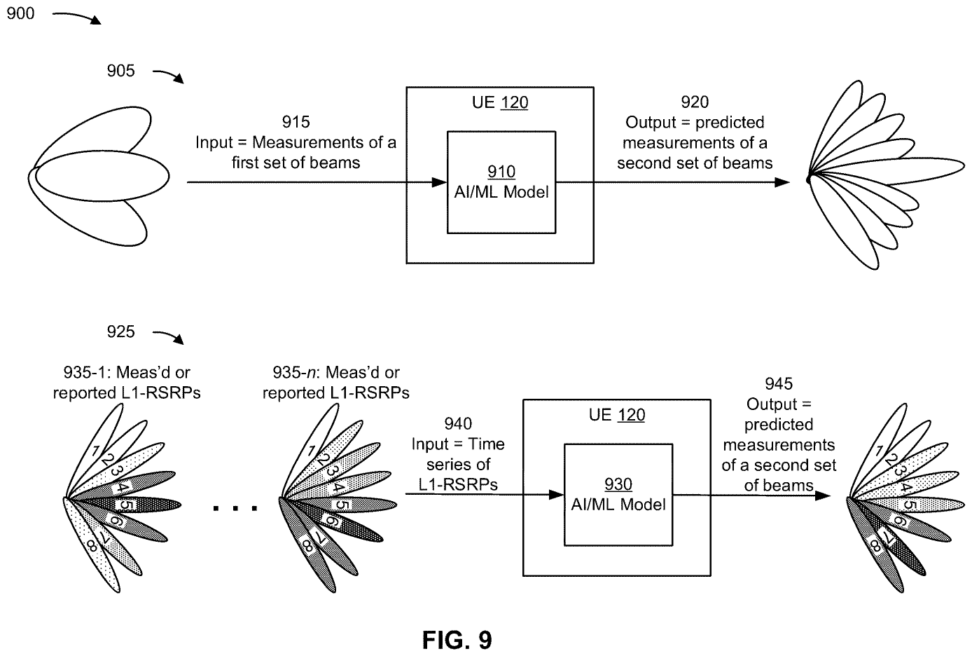

In some aspects, channel characteristics associated with one or more of the beams described above in connection with the various beam management procedures may be directly measured by a wireless communication device, such as by the UE 120. However, in some other aspects, channel characteristics associated with one or more of the beams described above in connection with the various beam management procedures may be inferred and/or predicted based at least in part on channel characteristics associated with other beams, such as via use of an AI/ML model. Aspects of using channel characteristics of certain beams to predict channel characteristics associated with other beams are described in more detail below in connection with FIGS. 8 and 9.

As indicated above, FIG. 7 is provided as an example of beam management procedures. Other examples of beam management procedures may differ from what is described with respect to FIG. 7. For example, the UE 120 and the BS 110 may perform the third beam management procedure before performing the second beam management procedure, and/or the UE 120 and the BS 110 may perform a similar beam management procedure to select a UE 120 transmit beam.

FIG. 8 is a diagram illustrating an example architecture 800 of a functional framework for RAN intelligence enabled by data collection, in accordance with the present disclosure. In some scenarios, the functional framework for RAN intelligence may be enabled by further enhancement of data collection through use cases and/or examples. For example, principles or algorithms for RAN intelligence enabled by AI/ML and the associated functional framework (e.g., the AI functionality and/or the input/output of the component for AI enabled optimization) have been utilized or studied to identify the benefits of AI enabled RAN through possible use cases (e.g., beam management, energy saving, load balancing, mobility management, and/or coverage optimization, among other examples). In one example, as shown by the architecture 800, a functional framework for RAN intelligence may include multiple logical entities, such as a model training host 802, a model inference host 804, data sources 806, and an actor 808.

The model inference host 804 may be configured to run an AI/ML model based on inference data provided by the data sources 806, and the model inference host 804 may produce an output (e.g., a prediction) with the inference data input to the actor 808. The actor 808 may be an element or an entity of a core network or a RAN. For example, the actor 808 may be a UE 120, a BS 110 or another network node (e.g., a gNB, a CU, a DU, and/or an RU), among other examples. In addition, the actor 808 may also depend on the type of tasks performed by the model inference host 804, type of inference data provided to the model inference host 804, and/or type of output produced by the model inference host 804. For example, if the output from the model inference host 804 is associated with beam management (such as the AI/ML models described in more detail below in connection with FIG. 9), the actor 808 may be a UE 120, a DU, or an RU, and if the output from the model inference host 804 is associated with transmission and/or reception scheduling, the actor 808 may be a CU or a DU.

After the actor 808 receives an output from the model inference host 804, the actor 808 may determine whether to act based on the output. For example, if the actor 808 is a DU or an RU and the output from the model inference host 804 is associated with beam management, the actor 808 may determine whether to change/modify a transmission and/or reception beam based on the output. If the actor 808 determines to act based on the output, the actor 808 may indicate the action to at least one subject of action 810. For example, if the actor 808 determines to change/modify a transmission and/or reception beam for a communication between the actor 808 and the subject of action 810 (e.g., a UE 120), then the actor 808 may transmit a beam (re-)configuration or a beam switching indication to the subject of action 810. The actor 808 may modify its transmission and/or reception beam based on the beam (re-)configuration, such as switching to a new transmission and/or reception beam or applying different parameters for a transmission and/or reception beam, among other examples. As another example, the actor 808 may be a UE 120 and the output from the model inference host 804 may be associated with beam management. For example, the output may be one or more predicted measurement values for one or more beams. The actor 808 (e.g., a UE 120) may determine that a measurement report (e.g., a Layer 1 (L1) RSRP report) is to be transmitted to a BS 110.

The data sources 806 may also be configured for collecting data that is used as training data for training an ML model or as inference data for feeding an ML model inference operation. For example, the data sources 806 may collect data from one or more core network and/or RAN entities, which may include the subject of action 810, and provide the collected data to the model training host 802 for ML model training. For example, after a subject of action 810 (e.g., a UE 120) receives a beam configuration from the actor 808, the subject of action 810 may provide performance feedback associated with the beam configuration to the data sources 806, where the performance feedback may be used by the model training host 802 for monitoring or evaluating the ML model performance, such as whether the output (e.g., prediction) provided to the actor 808 is accurate. In some examples, if the output provided by the actor 808 is inaccurate (or the accuracy is below an accuracy threshold), then the model training host 802 may determine to modify or retrain the ML model used by the model inference host, such as via an ML model deployment/update.

As indicated above, FIG. 8 is provided as an example. Other examples may differ from what is described with regard to FIG. 8.

FIG. 9 is a diagram illustrating an example 900 of AI/ML models, in accordance with the present disclosure. As shown in the example indicated by reference number 905 in FIG. 9, an AI/ML model 910 may be deployed at or on a UE 120 for a purpose of spatial domain beam prediction (sometimes referred to as a beam management case 1, or simply “BM-Case1”). For example, a model inference host (such as a model inference host 804) may be deployed at, or on, a UE 120. The AI/ML model 910 may enable the UE 120 to determine one or more inferences or predictions based on data input to the AI/ML model 910.

For example, as shown by reference number 915, an input to the AI/ML model 910 may include measurements associated with a first set of beams. For example, a BS 110 or a similar network node (e.g., a CU, a DU, an RU, and/or a similar network entity) may transmit one or more signals via respective beams from the first set of beams. The UE 120 may perform measurements (e.g., L1 RSRP measurements or other measurements) of the first set of beams or a subset thereof to obtain a first set of measurements (sometimes referred to as channel characteristics). For example, each beam (or else a subset thereof), from the first set of beams, may be associated with one or more measurements performed by the UE 120. The UE 120 may input the first set of measurements (e.g., L1 RSRP measurement values) into the AI/ML model 910 along with information associated with the first set of beams (or a subset thereof), such as a beam direction (e.g., spatial direction), beam width, beam shape, and/or other characteristics of the respective beams from the first set of beams (or subset thereof).

As shown by reference number 920, the AI/ML model 910 may output one or more predictions. The one or more predictions may include predicted measurement values and/or channel characteristics (e.g., predicted L1 RSRP measurement values) associated with a second set of beams. This may reduce a quantity of beam measurements that are performed by the UE 120, thereby conserving power of the UE 120 and/or network resources that would have otherwise been used to measure all beams included in the first set of beams and the second set of beams. This type of prediction may be referred to as a codebook-based spatial domain selection or prediction.

As another example, an output of the AI/ML model 910 may include a point-direction, an angle of departure (AoD), and/or an angle of arrival (AoA) of a beam included in the second set of beams (e.g., Set A beams). This type of prediction may be referred to as a non-codebook-based spatial domain selection or prediction. As another example, multiple measurement reports or values, collected at different points in time, may be input to the AI/ML model 910. This may enable the AI/ML model 910 to output codebook-based and/or non-codebook-based predictions for a measurement value, an AoD, and/or an AoA, among other examples, of a beam at a future time. The output(s) of the AI/ML model 910, as described herein, may facilitate initial access procedures, secondary cell group (SCG) setup procedures, beam refinement procedures (e.g., a P2 beam management procedure or a P3 beam management procedure as described above in connection with FIG. 7), link quality or interference adaptation procedures, beam failure and/or beam blockage predictions, and/or radio link failure predictions, among other examples.

In some examples, beam measurement predictions may be performed by a UE (e.g., as depicted in FIG. 9) and/or by a BS 110 or a similar network node (e.g., a CU, a DU, an RU, and/or a similar network entity) in a similar manner as described above. For example, a network node may receive one or more measurements (e.g., performed by a UE 120) and may use an AI/ML model 910 to predict one or more measurements (e.g., of other beams) based at least in part on the one or more measurements performed by the UE 120. For example, predictions may be performed by a network node because the network node may have more processing resources and/or a greater processing capability than a UE 120. Additionally, the network node may have access to historical measurement reports and/or measurement reports from other UEs that may be used as inputs to the AI/ML model 910 (e.g., which may improve an accuracy of an output of the AI/ML model 910). Predictions may be performed by the UE 120 because the UE 120 may have access to filtered measurements of all beams (e.g., not all measurements may be reported to the network node). Additionally, the UE 120 may have information related to the receive beam(s) used to derive or perform the measurements (e.g., which may be a useful input for the AI/ML model 910). As another example, the measurement information at the UE 120 may be “raw” or non-quantized, thereby providing more information that can be input into the AI/ML model 910. Further, the UE 120 may have knowledge of an orientation or a rotational position of the UE 120.

In some examples, the first set of beams (e.g., that are measured) may be referred to as Set B beams and the second set of beams (e.g., that are associated with predicted measurements) may be referred to as Set A beams. Put another way, Set B beams may be a set of beams for which measurements are taken as inputs of the AI/ML model 910, and Set A beams may be a set of beams for which the AI/ML model 910 performs predictions. In some examples, the first set of beams (e.g., the Set B beams) may be a subset of the second set of beams (e.g., the Set A beams). In some other examples, the first set of beams and the second set of beams may be different beams and/or may be mutually exclusive sets. For example, the first set of beams (e.g., the Set B beams) may include wide beams (e.g., unrefined beams or beams having a beam width that satisfies a first threshold) and the second set of beams (e.g., the Set A beams) may include narrow beams (e.g., refined beams or beams having a beam width that satisfies a second threshold). In one example, the AI/ML model 910 may perform spatial-domain downlink beam predictions for beams included in the Set A beams based on measurement results of beams included in the Set B beams. As another example, the AI/ML model 910 may perform temporal downlink beam prediction for beams included in the Set A beams based on historic measurement results of beams included in the Set B beams.

More particularly, as shown in the example indicated by reference number 925 in FIG. 9, an AI/ML model 930 may be deployed at or on a UE 120 for a purpose of temporal domain beam prediction (sometimes referred to as a beam management case 2, or simply “BM-Case2”). The AI/ML model 930 may enable the UE 120 to determine one or more inferences or predictions based on data input to the AI/ML model 930. Moreover, although the AI/ML model 930 is shown and described as being located at a UE 120, in some other examples the AI/ML model 930 may be located at another network device, such as a network node (e.g., a BS 110, a CU, a DU, an RU, and/or a similar network entity). In that regard, one or more of the operations described below as being performed by the UE 120 may alternatively be performed by a network node or other network device.

In some cases, for temporal beam prediction, a UE 120 may measure a first set of beams (e.g., Set B beams) over time, and predict, using the AI/ML model 930, measurements associated with a second set of beams (e.g., Set A beams) based at least in part on a time series of measurements of the first set of beams. For temporal beam prediction, Set B and Set A may include the same beams (e.g., Set B and Set A may be the same), the beams included in Set B may be a subset of the beams included in Set A, or else the beams included in Set B may be different beams than the beams included in Set A (e.g., Set B may not be a subset of Set A).

As shown by reference number 935, the UE 120 may perform a set of beam measurements or else receive a set of reported beam measurements for the Set B beams over time. For example, at a first time, the UE 120 may perform set of beam measurements (e.g., L1-RSRP measurements), as indicated by reference number 935-1. The UE 120 may perform and/or receive additional measurements for the Set B beams over time, up to an nth time, as shown by reference number 935-n. As shown by reference number 940, a time series of the measurements (e.g., LI-RSRP measurements) associated with the Set B beams may be used as input to the AI/ML model 930. As shown by reference number 945, the AI/ML model 930 may output one or more predictions. The one or more predictions may include predicted measurement values and/or channel characteristics (e.g., predicted L1 RSRP measurement values) associated with a second set of beams (e.g., the Set A beams).

In some examples, a network device may perform a monitoring procedure associated with an AI/ML model, such as one of the AI/ML models 910, 930 described above or a similar AI/ML model. For example, the network device (e.g., a UE 120, a network node, or a similar network device) may monitor a performance of an AI/ML model, such as for purposes of model activation (e.g., determining whether an AI/ML model is to be activated at a network device), model deactivation (e.g., determining whether an AI/ML model is to be deactivated at a network device), model selection (e.g., determining which AI/ML model, of multiple candidate AI/ML models, is to be used by a network device), model switching (e.g., determining whether a network device is to switch from a first AI/ML model to a second AI/ML model), beam management fallback (e.g., determining whether a network device should revert to a non-AI/ML beam management procedure, such as one or more of the beam management procedures described above in connection with FIG. 7), model updating (e.g., determining whether an AI/ML model is to be updated and/or re-trained), or a similar purpose. In some cases, a monitoring procedure associated with an AI/ML model may be based at least in part on certain metrics and/or KPIs. For example, a monitoring procedure may be based at least in part on inference accuracy, in which case metrics related to intermediate KPIs may be used for the monitoring procedure. In some other examples, a monitoring procedure may be based at least in part on system accuracy, in which case metrics related to system performance KPIs may be used for the monitoring procedure. In some other examples, a monitoring procedure may be based at least in part on data distribution, which may include an input-based monitoring procedure (e.g., monitoring the validity of AI/ML model input, such as by using one or more of out-of-distribution detection techniques, drift detection of input data, signal-to-noise ratio (SNR) based techniques, delay-spread based techniques, or similar techniques) or an output-based monitoring procedure (e.g., monitoring the validity of AI/ML model output, such as by using a drift detection of output data technique). In some other examples, monitoring procedure may be based at least in part on another applicable condition or parameter.

In some cases, a monitoring procedure may be performed by a UE 120, a network node (e.g., a BS 110, a CU, a DU, an RU, and/or a similar network entity), or a combination of a UE 120 and a network node, among other network devices and/or combinations of network devices. For example, for BM-Case1 and BM-Case 2 with a UE-side model (as described above in connection with reference numbers 905 and 925), a UE may monitor performance metrics and make a monitoring decision (e.g., make a decision of AI/ML model selection, activation, deactivation, switching, and/or fallback operation) (which is sometimes referred to as UE-side model monitoring), a network node may monitor performance metrics and make a monitoring decision (which is sometimes referred to as network-side model monitoring), or a UE may monitor performance metrics and a network node may make a monitoring decision (which is sometimes referred to as hybrid model monitoring). In order for the UE 120 and/or the network node to monitor performance metrics and/or make a monitoring decision, the network node may periodically transmit, to the UE 120, dedicated downlink reference signals (sometimes referred to as auxiliary reference signals). The UE 120 may perform measurements on the dedicated downlink reference signals and compare the measurements to predicted measurements determined using an AI/ML model (e.g., the AI/ML model 910 and/or the AI/ML model 930) to identify whether the AI/ML model is accurately predicting measurements (which is sometimes referred to as periodic performance monitoring).

For example, in aspects in which an AI/ML model is associated with spatial beam prediction (such as the described above in connection with the AI/ML model 910) in which wide beams are used to predict narrow beams (as described above in connection with example shown by reference number 905) or else a subset of Set A beams are used to predicted measurements associated with a full set of Set A beams, a network node may transmit, to a UE 120, a full set of Set A beams every X milliseconds (ms) (e.g., every 500 ms) for a purpose of periodic performance monitoring. The UE 120 may measure the full set of Set A beams and compare the measurements to the predicted beam measurements generated as output of the AI/ML model 910 in order to identify whether the AI/ML model 910 is accurately predicting measurements. Similarly, in aspects in which an AI/ML model is associated with temporal beam prediction (such as the described above in connection with the AI/ML model 930), a network node may transmit, to a UE 120, a full set of Set A beams every X ms (e.g., every 500 ms) for a purpose of periodic performance monitoring. The UE 120 may measure the full set of Set A beams and compare the measurements to the predicted beam measurements generated as output of the AI/ML model 930 in order to identify whether the AI/ML model 930 is accurately predicting measurements.

In some examples, a periodicity of transmission of dedicated downlink reference signals (e.g., X in the above described examples, which is sometimes referred to as a performance monitoring periodicity), may depend on one or more factors associated with the UE 120, such as a UE 120 mobility status, a UE 120 location (e.g., a location of the UE 120 within a cell, such as whether the UE 120 is near a cell edge, a cell center, or the like), or similar factors. Moreover, in some examples, for periodic performance monitoring, a configuration of dedicated downlink reference signals may be done a priori (e.g., via an RRC configuration message) without using dynamic signaling to activate reference signal resources (e.g., CSI-RS resources), thus saving overhead.

In that way, multiple UEs 120 using AI/ML models may independently perform independent periodic performance monitoring of respective AI/ML models using dedicated downlink reference signals transmitted by a network node to each UE 120, and each UE 120 may thus make an independent monitoring decision about a respective AI/ML model. This may require high signaling overhead because the network node may periodically transmit dedicated downlink reference signals to each UE 120. Transmitting multiple instances of periodically reoccurring dedicated downlink reference signals (e.g., multiples set of dedicated downlink reference signals, one set to each UE using an AI/ML model) may result in high signaling overhead, crowded communication channels, decreased network throughput, increased network latency, and overall inefficient usage of network resources.

Some techniques and apparatuses described herein enable reduced signaling overhead associated with an AI/ML model monitoring procedure by enabling communication of AI/ML monitoring information using a sidelink between two or more UEs (e.g., UE 505-1 and UE 505-2 and/or Tx/Rx UE 605 and Rx/Tx UE 610, among other examples), such as when the two or more UEs are similar UEs (e.g., associated with a same make of UE or model UE) using a same type of AI/ML model (e.g., a same model of AI/ML model and/or AI/ML models that share model parameters and/or that are associated with a same model ID). The UEs may communicate monitoring information over a sidelink, such as for a purpose of reducing dedicated reference signals transmitted between the network node and at least one UE. For example, a first UE may receive dedicated reference signals from the network node and perform a monitoring procedure associated with an AI/ML model of the first UE (e.g., based at least in part on the dedicated reference signals). The first UE may in turn transmit monitoring information associated with the AI/ML model to a second UE. The second UE may perform a monitoring procedure associated with an AI/ML model of the second UE based at least in part on the monitoring information received from the first UE, without requiring dedicated reference signals to be transmitted by the network node to the second UE and/or based at least in part on a reduced amount of dedicated reference signals being transmitted by network node to the second UE. In this way, the network node may reduce or eliminate transmission of dedicated reference signals to one or more UEs for purposes of performing a monitoring procedure associated with an AI/ML model, resulting in less cluttered communication channels and thus increased throughput, reduced latency, and overall more efficient usage of network resources. Moreover, by sharing monitoring information across a sidelink, one or more UEs may be provided with additional information sources associated with a performance of an AI/ML model associated, thereby resulting in robust communication channels between one or more UEs and a network node and thus reduced communication errors.

As indicated above, FIG. 9 is provided as an example. Other examples may differ from what is described with regard to FIG. 9.

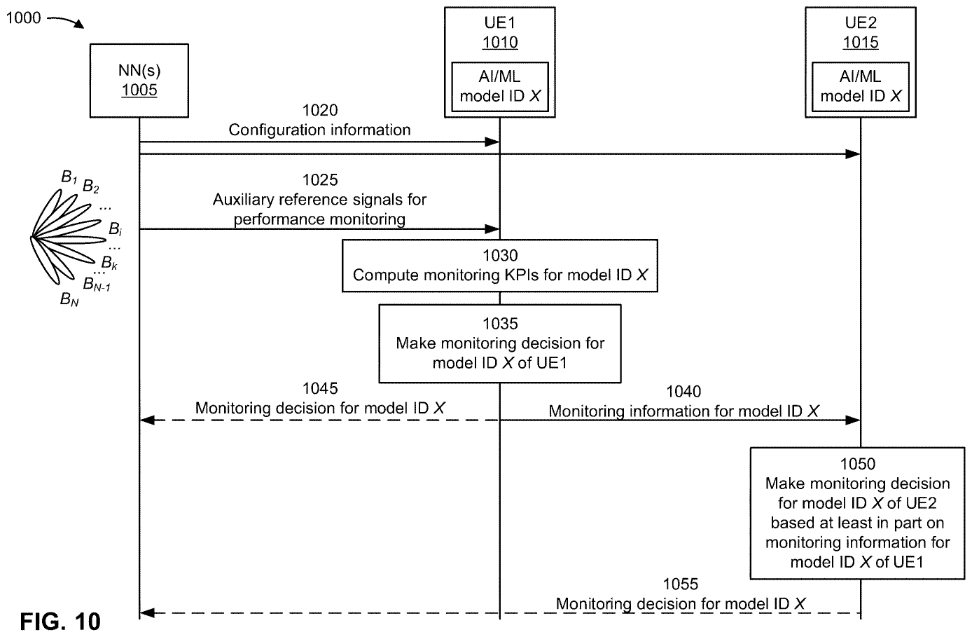

FIG. 10 is a diagram of an example 1000 associated with sidelink-assisted AI/ML model monitoring, in accordance with the present disclosure. As shown in FIG. 10, a network node 1005 (e.g., a BS 110, a CU, a DU, and/or an RU) may communicate with a first UE 1010 (e.g., shown as “UE1” in FIG. 10, which may correspond to UE 120, UE 505-1, UE 505-2, Tx/Rx UE 605, or Rx/Tx UE 610) and a second UE 1015 (e.g., shown as “UE2” in FIG. 10, which may correspond to UE 120, UE 505-1, UE 505-2, Tx/Rx UE 605, or Rx/Tx UE 610). Moreover, as shown in FIG. 10, the first UE 1010 may communicate with the second UE 1015. In some aspects, the network node 1005, the first UE 1010, and the second UE 1015 may be part of a wireless network (e.g., wireless communications network 100). The network node 1005, the first UE 1010, and/or the second UE 1015 may have established a wireless connection prior to operations shown in FIG. 10. For example, in a similar manner as described above in connection with FIG. 6, the network node 1005 may have established a wireless connection with the first UE 1010 and the second UE 1015 via respective access links, and/or the first UE 1010 may have established a wireless connection with the second UE 1015 via a sidelink. Additionally, or alternatively, the first UE 1010 and the second UE 1015 may be similar UEs. For example, the first UE 1010 and the second UE 1015 may be a same make of UE, a same model of UE, or may otherwise share similar UE parameters.

In some aspects, the first UE 1010 and/or the second UE 1015 may be associated with an AI/ML model (e.g., the first UE 1010 and the second UE 1015 may be using an AI/ML model to perform one or more beam management procedures, such as one or more of the beam management procedures described above in connection with FIGS. 7-9). Moreover, in some aspects, the AI/ML model of the first UE 1010 and the AI/ML model of the second UE 1015 may be associated with a same model ID, such as an AI/ML model associated with a model ID X, shown as “AI/ML model ID X” in FIG. 10. In that regard, an AI/ML model of the first UE 1010 and/or an AI/ML model of the second UE 1015 may be the same model (e.g., the first UE 1010 may be using a first copy of the AI/ML model ID X and/or the second UE 1015 may be using a second copy of the AI/ML model ID X), and/or the AI/ML model of the first UE 1010 and the AI/ML model of the second UE 1015 may share model parameters. For example, the AI/ML model of both the first UE 1010 and the second UE 1015 may be an AI/ML model developed by an original equipment manufacturer (OEM) vendor or chipset vendor that is shared across multiple similar UEs. As such, the AI/ML model of both the first UE 1010 and the second UE 1015 may be assigned a same model ID by the OEM vendor or chipset vendor, which may be representative of the AI/ML model structure and/or the AI/ML model parameters. In some aspects, the AI/ML model of the first UE 1010 and/or the second UE 1015 (e.g., AI/ML model ID X) may correspond to the AI/ML model 910, the AI/ML model 930, or a similar AI/ML model.

As shown by reference number 1020, the network node 1005 may transmit, and the first UE 1010 and/or the second UE 1015 may receive, configuration information. In some aspects, the first UE 1010 and/or the second UE 1015 may receive the configuration information via one or more of RRC signaling, one or more MAC-CEs, and/or DCI, among other examples. In some aspects, the configuration information may include an indication of one or more configuration parameters (e.g., already known to the first UE 1010 and/or the second UE 1015 and/or previously indicated by the network node 1005 or other network device) for selection by the first UE 1010 and/or the second UE 1015, and/or explicit configuration information for the first UE 1010 and/or the second UE 1015 to use to configure the first UE 1010 and/or the second UE 1015, among other examples.

In some aspects, the configuration information may indicate, to the first UE 1010 and/or the second UE 1015, that another UE in communication with network node 1005 is a similar UE as the first UE 1010 and/or the second UE 1015 (e.g., that the other UE is a same make of UE, a same model of UE, and/or a UE sharing similar UE parameters as the first UE 1010 and/or the second UE 1015), that another UE in communication with the network node 1005 is associated with (e.g., using) a same or similar AI/ML model as the first UE 1010 and/or the second UE 1015 (e.g., that the other UE is using an AI/ML model having a same model ID as a model ID of an AI/ML model of the first UE 1010 and/or the second UE 1015, that the other UE is using an AI/ML model sharing model parameters as a model ID of an AI/ML model of the first UE 1010 and/or the second UE 1015, or the like), and/or other information associated with another UE. For example, in aspects in which both the first UE 1010 and the second UE 1015 are using the AI/ML model ID X, the configuration information may indicate, to the first UE 1010, that the second UE 1015 is a similar UE 120 as the first UE 1010 and/or that the second UE 1015 is using the AI/ML model ID X. Similarly, the configuration information may indicate, to the second UE 1015, that the first UE 1010 is a similar UE 120 as the second UE 1015 and/or that the first UE 1010 is using the AI/ML model ID X. In this way, the configuration information may indicate to the first UE 1010 and/or the second UE 1015 that monitoring information associated with an AI/ML model monitoring procedure performed at one UE may be applicable to an AI/ML model monitoring procedure performed at another UE because the UEs are similar, are associated with a same or similar AI/ML model, are within a same cell and/or in communication with a same network node, or are otherwise similarly situated.

The configuration information may indicate additional information and/or parameters associated with performing an AI/ML model monitoring procedure. For example, in some aspects, the first UE 1010 and/or the second UE 1015 may be configured to perform an AI/ML model monitoring procedure based at least in part on measuring auxiliary reference signals, as described above in connection with FIG. 9. In such aspects, the configuration information may indicate parameters associated with the auxiliary reference signals, such as a number of beams associated with the auxiliary reference signals, a periodicity of the auxiliary reference signals, or similar information.

The first UE 1010 and/or the second UE 1015 may configure themselves based at least in part on the configuration information. In some aspects, the first UE 1010 and/or the second UE 1015 may be configured to perform one or more operations described herein based at least in part on the configuration information.

As shown by reference number 1025, the network node 1005 may transmit, and the first UE 1010 may receive, one or more reference signals associated with a monitoring procedure for an AI/ML model of the first UE 1010 (e.g., one or more auxiliary reference signals). In some aspects, the one or more reference signals may be associated with multiple beams. For example, in the example shown in FIG. 10, the auxiliary reference signals may be associated with N beams (with the N beams shown as beam B₁ through beam B_{N}). As described above in connection with FIG. 9, the first UE 1010 may measure the auxiliary reference signals, compare the measurements to predictions outputted by the AI/ML model of the first UE 102-1 (e.g., AI/ML model ID X), and/or determine a performance of the AI/ML model of the first UE 1010. More particularly, as shown by reference number 1030, the first UE 1010 may compute one or more monitoring KPIs for the AI/ML model of the first UE 1010 (e.g., AI/ML model X), which may be used as part of a monitoring procedure for the AI/ML model of the first UE 1010.

As shown by reference number 1035, the first UE 1010 may perform the monitoring procedure for the AI/ML model of the first UE based at least in part on the one or more reference signals (e.g., based at least in part on the monitoring KPIs computed from measurements associated with the one or more reference signals) and/or the first UE 1010 may make a monitoring decision for the AI/ML model of the first UE 1010. For example, if the monitoring KPIs indicate that the AI/ML model of the first UE 1010 meets or exceeds certain performance benchmarks (e.g., KPI thresholds), the first UE 1010 may make a monitoring decision to either continue to use the AI/ML model of the first UE 1010 if the AI/ML model of the first UE 1010 is already activated, or else activate the AI/ML model of the first UE 1010 if the AI/ML model of the first UE 1010 is not already activated. Similarly, if the monitoring KPIs indicate that AI/ML model of the first UE 1010 does not meet certain performance benchmarks (e.g., KPI thresholds), the first UE 1010 may determine to deactivate the AI/ML model of the first UE 1010 and/or switch to a different AI/ML model (e.g., an AI/ML model associated with an ID other than X). In some aspects, if the monitoring KPIs indicate that the AI/ML model of the first UE 1010 does not meet certain performance benchmarks (e.g., KPI thresholds), the first UE 1010 may determine to use a fallback operation that does not utilize an AI/ML model for performing beam management procedures. For example, the first UE 1010 may determine to use a CSI-RS-based beam management procedure that does not implement an AI/ML model, such as one or more of the beam management procedures described above in connection with FIG. 7.

In some aspects, multiple UEs, such as the first UE 1010 and the second UE 1015, among others, may be configured to perform a collaborative monitoring procedure for respective AI/ML models, in which monitoring decisions and/or information are shared with each other across a sidelink, and/or in which each UE may incorporate the monitoring decisions by other UEs and/or monitoring information from other UEs into a monitoring decision performed by the UE. Accordingly, as shown by reference number 1040, in some aspects the first UE 1010 may transmit, and the second UE 1015 may receive (e.g., via the sidelink), monitoring information associated with the AI/ML model of the first UE 1010. In some aspects, the first UE 1010 may transmit the monitoring information to the second UE 1015 using resources reserved by a sidelink resource allocation procedure, such the Mode 1 sidelink resource allocation procedure or the Mode 2 sidelink resource allocation procedure described above in connection with FIG. 5.

The monitoring information may include an indication of one or more AI/ML model IDs, an indication of a monitoring decision made by the first UE 1010 associated with the one or more AI/ML model IDs (e.g., a decision to activate a particular AI/ML model, deactivate a particular AI/ML model, switch between AI/ML models, and/or utilize a fallback, non-AI/ML-based beam management procedure), and/or other information used by the first UE 1010 to make a monitoring decision (e.g., one or more beam measurements, monitoring KPIs, or the like).

For example, in some aspects, the monitoring information may include an indication that the first UE 1010 selected or is selecting the AI/ML model of the first UE 1010 from multiple AI/ML models (e.g., multiple candidate AI/ML models that can be selected for use by a UE). Put another way, the first UE 1010 may notify the second UE 1015 that the first UE 1010 is selecting a given AI/ML model ID (e.g., AI/ML model ID X) based on a given scenario, configuration, or similar information. In some other aspects, the monitoring information may include an indication that the first UE 1010 activated or is activating the AI/ML model of the first UE 1010. Put another way, the first UE 1010 may notify the second UE 1015 that the first UE 1010 is activating a given AI/ML model ID (e.g., AI/ML model ID X). In some other aspects, the monitoring information may include an indication that the first UE 1010 deactivated or is deactivating the AI/ML model of the first UE 1010. Put another way, the first UE 1010 may notify the second UE 1015 that the first UE 1010 is deactivating a given AI/ML model ID (e.g., AI/ML model ID X).

In some other aspects, the monitoring information may include an indication that the first UE 1010 switched or is switching between the AI/ML model of the first UE 1010 and another AI/ML model. Put another way, the first UE 1010 may notify the second UE 1015 that the first UE 1010 is switching between a first AI/ML model ID (e.g., AI/ML model ID X) and a second AI/ML model ID (e.g., a AI/ML model having an ID other than X). In some other aspects, the monitoring information may include an indication that that first UE 1010 switched or is switching from using the AI/ML model of the first UE 1010 to using a non-AI/ML beam management procedure (e.g., one or more of the beam management procedures described above in connection with FIG. 7, or a similar beam management procedure). Put another way, the first UE 1010 may notify the second UE 1015 that the first UE 1010 is falling back from using an AI/ML model with the signaled model ID (e.g., AI/ML model ID X) to a non-AI/ML algorithm (e.g., a non-AI/ML proprietary algorithm). In aspects in which the first UE 1010 and the second UE 1015 are similar UEs (e.g., in which the first UE 1010 and the second UE 1015 are a same make of UE and/or a same model of UE), the proprietary algorithm may be shared across the UEs, and thus an indication that the first UE 1010 is falling back from an AI/ML model with the signaled model ID to a non-AI/ML proprietary algorithm may be leveraged by the second UE 1015.

In some other aspects, instead of, or else in addition to, one or more of the monitoring decisions described above, the monitoring information may include certain intermediate information used by the first UE 1010 to perform the monitoring procedure at the first UE 1010 and/or to make a monitoring decision at the first UE 1010. For example, in some aspects the monitoring information may include information related to KPIs, such as intermediate KPIs and/or monitoring KPIs (e.g., the monitoring KPIs described above in connection with reference number 1030), intermediate information about the performance of an AI/ML model (e.g., AI/ML model ID X), or similar information.

Additionally, or alternatively, the monitoring information may be associated with auxiliary information associated with a use case related to the first UE 1010. The auxiliary information associated with the use case of the first UE 1010 may include certain parameters and/or characteristics of the first UE 1010 that may affect a performance of the AI/ML model. In such aspects, the second UE 1015 may use the auxiliary information associated with the use case of the first UE 1010 to determine whether the monitoring information is applicable to a monitoring procedure to be performed at the second UE 1015 (which is described in more detail below in connection with reference number 1050). For example, if the use case of the AI/ML model of the first UE 1010 differs significantly from a use case of the AI/ML model of the second UE 1015, the monitoring information (e.g., the monitoring KPIs and/or information associated with one or more monitoring decisions at the first UE 1010) may not be applicable to a monitoring procedure performed at the second UE 1015. However, if a use case of the AI/ML model of the first UE 1010 is similar to a use case of the AI/ML model of the second UE 1015, the monitoring information may be relevant to a monitoring procedure performed at the second UE 1015.

For example, in some aspects the AI/ML model of the first UE 1010 and/or the second UE 1015 (e.g., AI/ML model X) may be associated with temporal beam prediction, as described above in connection with the AI/ML model 930. In such aspects, a mobility of a respective UE (e.g., a speed of a respective UE) may affect a performance of the AI/ML model. Accordingly, in an example in which the first UE 1010 is traveling at a speed of 30 kilometers/hour (km/h) and makes a monitoring decision to deactivate the AI/ML model, the monitoring decision of the first UE 1010 and/or monitoring information associated with the monitoring decision of the first UE 1010 may not be applicable to the second UE 1015, which may be moving at a speed of 5 km/h. Put another way, a given AI/ML model (e.g., AI/ML model ID X) may perform poorly when used by a UE 120 traveling at 30 km/h but may perform well when used by a UE 120 traveling at 5 km/h. In such examples, in addition to monitoring information, the first UE 1010 may transmit, to the second UE 1015, some auxiliary information specific to a particular use case of the first UE 1010 (e.g., an indication of UE speed for temporal beam prediction). In addition to UE speed, other auxiliary information that may affect the performance of the AI/ML model may be shared between UEs, such as UE orientation, blockage information (e.g., information associated with a user's hand grip on the UE), or similar information.

As shown by reference number 1045, in some aspects the first UE 1010 may inform the network node 1005 of a monitoring decision associated with the AI/ML model of the first UE 1010. For example, the first UE 1010 may inform the network node 1005 that the first UE 1010 selected or is selecting AI/ML model ID X from multiple AI/ML models, activated or is activating the AI/ML model ID X, deactivated or is deactivating the AI/ML model ID X, switched or is switching between the AI/ML model ID X and another AI/ML model, or switched or is switching between using AI/ML model ID X and using a non-AI/ML beam management procedure. In such aspects, the network node 1005 may take one or more actions based at least in part on the information described above in connection with reference number 1045, such as by scheduling additional reference signals (e.g., CSI-RSs and/or auxiliary reference signals for monitoring purposes) to be used by the first UE 1010 as part of an AI/ML monitoring procedure and/or non-AI/ML beam management procedure, or a similar action.

As shown by reference number 1050, the second UE 1015 may make a monitoring decision for an AI/ML model of the second UE 1015 (e.g., AI/ML model ID X) based at least in part on the monitoring information received from the first UE 1010. Put another way, in some aspects the second UE 1015 may perform a monitoring procedure associated with an AI/ML model of the second UE 1015 (e.g., an AI/ML model used by the second UE 1015) based at least in part on the monitoring information associated with the AI/ML model of the first UE 1010. Moreover, in aspects in which the first UE 1010 transmitted auxiliary information associated with a use case of the first UE 1010 to the second UE 1015, the second UE 1015 may further perform the monitoring procedure associated with the AI/ML model of the second UE 1015 based at least in part on the auxiliary information associated with the use case associated with the first UE 1010. In this regard, when the first UE 1010 and the second UE 1015 are similar UEs (e.g., are the same make of UE and/or model of UE), use the same AI/ML model (e.g., use AI/ML models sharing the same model ID and/or model parameters), and/or are associated with similar use cases (e.g., are associated with a same velocity, orientation, hand grid, or similar parameters), the performance of the AI/ML model of the first UE 1010 may be indicative and/or predictive of the performance of the AI/ML model of the second UE 1015. Put another way, if two similar UEs (e.g., the first UE 1010 and the second UE 1015) using the same AI/ML model (e.g., AI/ML model ID X) are deployed in a given area, the performance of the AI/ML model of a first UE may provide useful insights about the performance of the AI/ML model of a second UE. Thus, as shown in FIG. 10, the second UE 1015 may utilize the monitoring information received from the first UE 1010 in order to determine a performance of the AI/ML model of the second UE 1015. This may reduce or eliminate auxiliary reference signals that would otherwise need to be transmitted by the network node 1005 to the second UE 1015 for purposes of performing a monitoring procedure.

As shown by reference number 1055, in some aspects the second UE 1015 may inform the network node 1005 of a monitoring decision associated with the AI/ML model of the second UE 1015. For example, the second UE 1015 may inform the network node 1005 that the second UE 1015 selected or is selecting AI/ML model ID X from multiple AI/ML models, activated or is activating the AI/ML model ID X, deactivated or is deactivating the AI/ML model ID X, switched or is switching between the AI/ML model ID X and another AI/ML model, or switched or is switching between using AI/ML model ID X and using a non-AI/ML beam management procedure. In such aspects, the network node 1005 may take one or more actions based at least in part on the information described above in connection with reference number 1055, such as by scheduling additional reference signals (e.g., CSI-RSs and/or auxiliary reference signals for monitoring purposes) to be used by the second UE 1015 as part of an AI/ML monitoring procedure and/or non-AI/ML beam management procedure, or a similar action.

Based at least in part on the UEs 1010, 1015 and the network node 1005 using a sidelink-assisted AI/ML model monitoring procedure, such as one or more of the operations described above in connections with reference numbers 1020-1055, the UEs 1010, 1015 and/or the network node 1005 may conserve computing, power, network, and/or communication resources that may have otherwise been consumed by a non-sidelink-assisted AI/ML model monitoring procedure. For example, based at least in part on the UEs 1010, 1015 and the network node 1005 using a sidelink-assisted AI/ML model monitoring procedure, the UEs 1010, 1015 and the network node 1005 may reduce an amount of auxiliary reference signals required for monitoring procedures, which may reduce network congestion, increase throughput, decrease latency, and otherwise result in more efficient usage of network resources.

As indicated above, FIG. 10 is provided as an example. Other examples may differ from what is described with respect to FIG. 10.

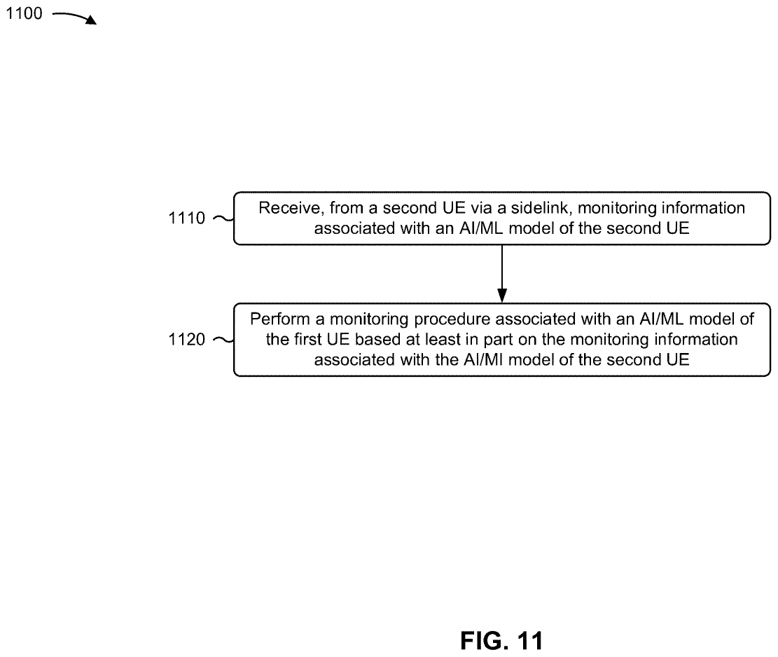

FIG. 11 shows a method 1100 for wireless communications by a first UE, such as UE 1015.

Method 1100 begins at 1110 with receiving, from a second UE via a sidelink, monitoring information associated with an AI/ML model of the second UE.

Method 1100 then proceeds to step 1120 with performing a monitoring procedure associated with an AI/ML model of the first UE based at least in part on the monitoring information associated with the AI/ML model of the second UE.

In one aspect, the AI/ML model of the first UE is associated with a beam management procedure.

In one aspect, the monitoring information includes at least one of a monitoring decision of a monitoring procedure for the AI/ML model of the second UE or monitoring key performance indicators used for the monitoring procedure for the AI/ML model of the second UE.

In one aspect, the monitoring procedure associated with the AI/ML model of the first UE is a procedure used to measure a performance of the AI/ML model of the first UE.

In one aspect, performing the monitoring procedure associated with the AI/ML model of the first UE includes using at least one of a monitoring decision of a monitoring procedure of the AI/ML model of the second UE, or monitoring key performance indicators used for the monitoring procedure of the AI/ML model of the second UE, for making a monitoring decision of the AI/ML model of the first UE.

In one aspect, the AI/ML model of the first UE and the AI/ML model of the second UE are the same model.

In one aspect, the AI/ML model of the first UE is associated with an AI/ML model structure and a first set of AI/ML model parameters, and the AI/ML model of the second UE is associated with the AI/ML model structure and a second set of AI/ML model parameters different from the first set of AI/ML model parameters.

In one aspect, the first UE and the second UE are of a same make of UE or a same model of UE.

In one aspect, the first UE is in communication with a network node and the second UE is in communication with the network node.

In one aspect, method 1100 further includes receiving, from a network node via an access link, configuration information indicating that the second UE is associated with the AI/ML model of the second UE.

In one aspect, the monitoring information associated with the AI/ML model of the second UE includes at least one of an indication that the second UE selected or is selecting the AI/ML model of the second UE from multiple AI/ML models, an indication that the second UE activated or is activating the AI/ML model of the second UE, an indication that the second UE deactivated or is deactivating the AI/ML model of the second UE, an indication that the second UE switched or is switching between the AI/ML model of the second UE and another AI/ML model, or an indication that that second UE switched or is switching between using the AI/ML model of the second UE and using a non-AI/ML beam management procedure.

In one aspect, the monitoring information is received via resources associated with one of a Mode 1 sidelink resource allocation procedure or a Mode 2 sidelink resource allocation procedure.

In one aspect, the resources are one of reserved, by a network node, for use by the second UE for the Mode 1 sidelink resource allocation procedure, or selected, by one of the first UE or the second UE, for use by the second UE for the Mode 2 sidelink resource allocation procedure.

In one aspect, the monitoring information associated with the AI/ML model of the second UE includes auxiliary information associated with a use case related to the second UE.

In one aspect, the auxiliary information associated with the use case related to the second UE includes at least one of a velocity of the second UE, an orientation of the second UE, or a signal blockage of the second UE.

In one aspect, performing the monitoring procedure associated with the AI/ML model of the first UE includes comparing the auxiliary information associated with the second UE to auxiliary information associated with a use case related to the first UE.

In one aspect, the AI/ML model of the first UE and the AI/ML model of the second UE are associated with a same model identifier.

In one aspect, method 1100 further includes transmitting, to a network node via an access link, an indication associated with a monitoring decision by the first UE.

Note that FIG. 11 is just one example of a method, and other methods including fewer, additional, or alternative steps are possible consistent with this disclosure.

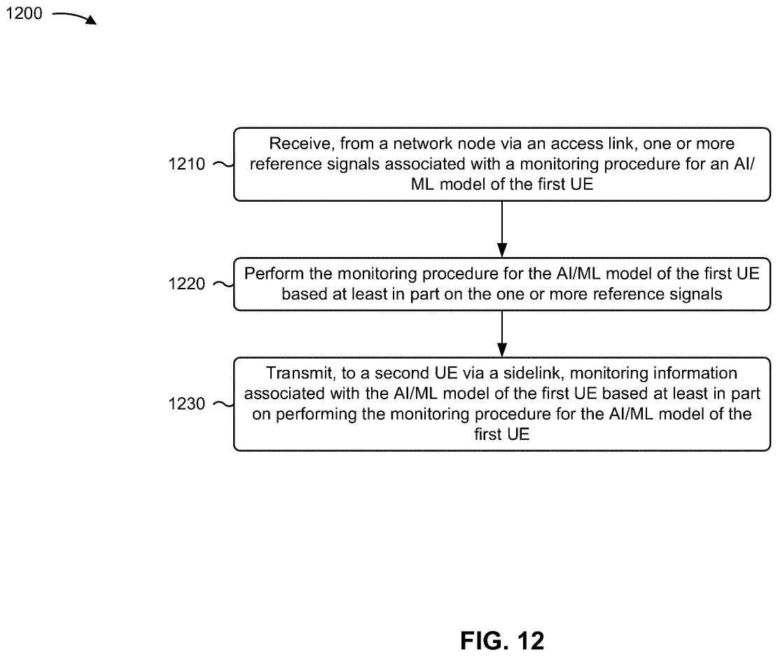

FIG. 12 shows a method 1200 for wireless communications by a first UE, such as UE 1010.

Method 1200 begins at 1210 with receiving, from a network node via an access link, one or more reference signals associated with a monitoring procedure for an AI/ML model of the first UE.

Method 1200 then proceeds to step 1220 with performing the monitoring procedure for the AI/ML model of the first UE based at least in part on the one or more reference signals.

Method 1200 then proceeds to step 1230 with transmitting, to a second UE via a sidelink, monitoring information associated with the AI/ML model of the first UE based at least in part on performing the monitoring procedure for the AI/ML model of the first UE.

In one aspect, the AI/ML model of the first UE is associated with a beam management procedure.

In one aspect, the monitoring information includes at least one of a monitoring decision of the monitoring procedure for the AI/ML model of the first UE or monitoring key performance indicators used for the monitoring procedure for the AI/ML model of the first UE.

In one aspect, the monitoring procedure includes performing measurements on the reference signals and comparing the measurements to outputs of the AI/ML model of the first UE.

In one aspect, the AI/ML model of the first UE and an AI/ML model of the second UE are the same model.

In one aspect, the AI/ML model of the first UE is associated with an AI/ML model structure and a first set of AI/ML model parameters, and an AI/ML model of the second UE is associated with the AI/ML model structure and a second set of AI/ML model parameters different from the first set of AI/ML model parameters.

In one aspect, the first UE and the second UE are a same make of UE or a same model of UE.

In one aspect, the first UE is in communication with the network node and the second UE is in communication with the network node.

In one aspect, the method 1200 further includes receiving, from the network node via the access link, configuration information indicating that the second UE is associated with an AI/ML model of the second UE.

In one aspect, the monitoring information associated with the AI/ML model of the first UE includes at least one of an indication that the first UE selected or is selecting the AI/ML model of the first UE from multiple AI/ML models, an indication that the first UE activated or is activating the AI/ML model of the first UE, an indication that the first UE deactivated or is deactivating the AI/ML model of the first UE, an indication that the first UE switched or is switching between the AI/ML model of the first UE and another AI/ML model, or an indication that that first UE switched or is switching between using the AI/ML model of the first UE and using a non-AI/ML beam management procedure.

In one aspect, the monitoring information is transmitted via resources associated with one of a Mode 1 sidelink resource allocation procedure or a Mode 2 sidelink resource allocation procedure.

In one aspect, the resources are one of reserved, by the network node, for use by the first UE for the Mode 1 sidelink resource allocation procedure, or selected, by one of the first UE or the second UE, for use by the first UE for the Mode 2 sidelink resource allocation procedure.

In one aspect, the monitoring information associated with the AI/ML model of the first UE includes auxiliary information associated with a use case related to the first UE.

In one aspect, the auxiliary information associated with the use case related to the first UE includes at least one of a velocity of the first UE, an orientation of the first UE, or a signal blockage of the first UE.

In one aspect, the AI/ML model of the first UE and the AI/ML model of the second UE are associated with a same model identifier.

In one aspect, the method 1200 further includes transmitting, to the network node via the access link, an indication associated with a monitoring decision by the first UE.

Note that FIG. 12 is just one example of a method, and other methods including fewer, additional, or alternative steps are possible consistent with this disclosure.

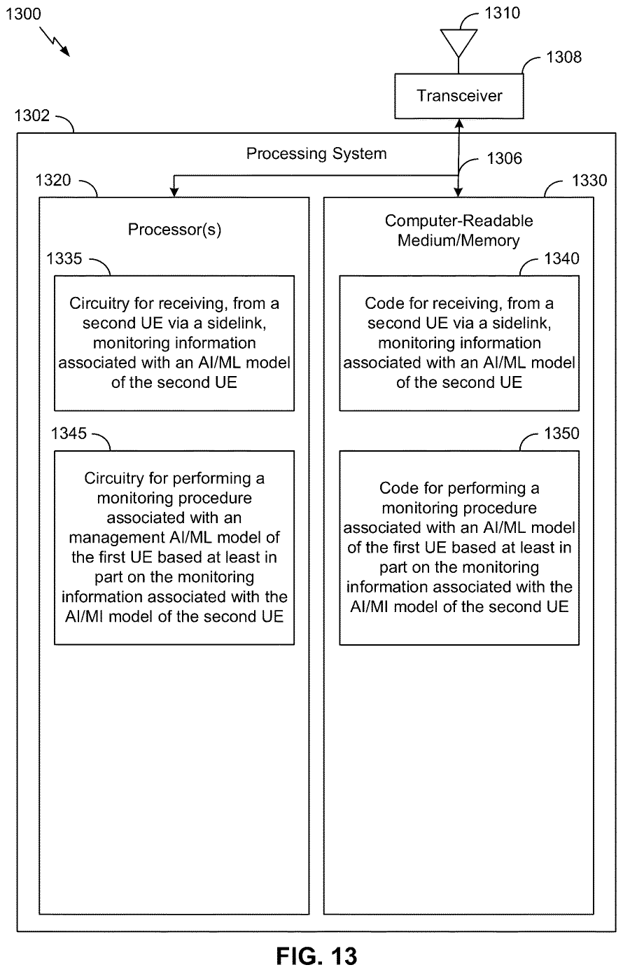

FIG. 13 is a diagram illustrating an example of an implementation of code and circuitry for a communications device 1300, in accordance with the present disclosure. The communications device 1300 may be a first UE (e.g., UE 1015), or a first UE may include the communications device 1300.

The communications device 1300 includes a processing system 1302 coupled to a transceiver 1308 (e.g., a transmitter and/or a receiver). The transceiver 1308 is configured to transmit and receive signals for the communications device 1300 via an antenna 1310, such as the various signals as described herein. The processing system 1302 may be configured to perform processing functions for the communications device 1300, including processing signals received and/or to be transmitted by the communications device 1300.

The processing system 1302 includes one or more processors 1320. In various aspects, the one or more processors 1320 may be representative of one or more of receive processor 258, transmit processor 264, TX MIMO processor 266, and/or controller/processor 280, as described with respect to FIG. 2. The one or more processors 1320 are coupled to a computer-readable medium/memory 1330 via a bus 1306. In various aspects, the computer-readable medium/memory 1330 may be representative of memory 282, as described with respect to FIG. 2. In certain aspects, the computer-readable medium/memory 1330 is configured to store instructions (e.g., computer-executable code, processor-executable code) that when executed by the one or more processors 1320, cause the one or more processors 1320 to perform the method 1100 described with respect to FIG. 11, or any aspect related to it. Note that reference to a processor performing a function of communications device 1300 may include one or more processors performing that function of communications device 1300.

As shown in FIG. 13, the communications device 1300 may include circuitry for receiving, from a second UE via a sidelink, monitoring information associated with an AI/ML model of the second UE (circuitry 1335).

As shown in FIG. 13, the communications device 1300 may include, stored in computer-readable medium/memory 1330, code for receiving, from a second UE via a sidelink, monitoring information associated with an AI/ML model of the second UE (code 1340).

As shown in FIG. 13, the communications device 1300 may include circuitry for performing a monitoring procedure associated with an AI/ML model of the first UE based at least in part on the monitoring information associated with the AI/ML model of the second UE (circuitry 1345).

As shown in FIG. 13, the communications device 1300 may include, stored in computer-readable medium/memory 1330, code for performing a monitoring procedure associated with an AI/ML model of the first UE based at least in part on the monitoring information associated with the AI/ML model of the second UE (code 1350).

Various components of the communications device 1300 may provide means for performing the method 1100 described with respect to FIG. 11, or any aspect related to it. For example, means for transmitting, sending, or outputting for transmission may include the transceiver(s) 254 and/or antenna(s) 252 of the UE 120 and/or transceiver 1308 and antenna 1310 of the communications device 1300 in FIG. 13. Means for receiving or obtaining may include the transceiver(s) 254 and/or antenna(s) 252 of the UE 120 and/or transceiver 1308 and antenna 1310 of the communications device 1300 in FIG. 13.

FIG. 13 is provided as an example. Other examples may differ from what is described in connection with FIG. 13.

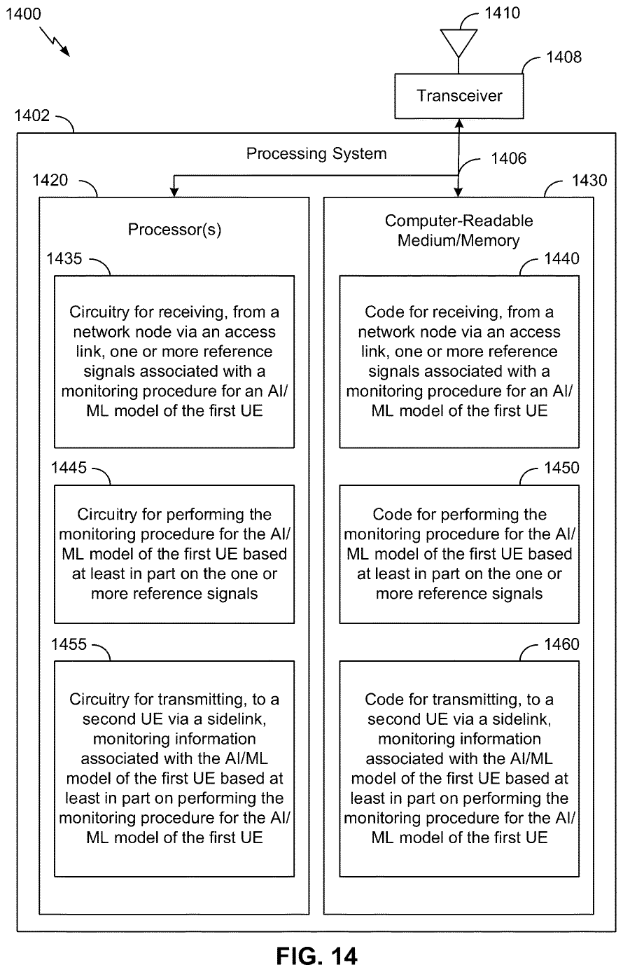

FIG. 14 is a diagram illustrating an example of an implementation of code and circuitry for a communications device 1400, in accordance with the present disclosure. The communications device 1400 may be a first UE (e.g., UE 1010), or a first UE may include the communications device 1400.

The communications device 1400 includes a processing system 1402 coupled to a transceiver 1408 (e.g., a transmitter and/or a receiver). The transceiver 1408 is configured to transmit and receive signals for the communications device 1400 via an antenna 1410, such as the various signals as described herein. The processing system 1402 may be configured to perform processing functions for the communications device 1400, including processing signals received and/or to be transmitted by the communications device 1400.

The processing system 1402 includes one or more processors 1420. In various aspects, the one or more processors 1420 may be representative of one or more of receive processor 258, transmit processor 264, TX MIMO processor 266, and/or controller/processor 280, as described with respect to FIG. 2. The one or more processors 1420 are coupled to a computer-readable medium/memory 1430 via a bus 1406. In various aspects, the computer-readable medium/memory 1430 may be representative of memory 282, as described with respect to FIG. 2. In certain aspects, the computer-readable medium/memory 1430 is configured to store instructions (e.g., computer-executable code, processor-executable code) that when executed by the one or more processors 1420, cause the one or more processors 1420 to perform the method 1200 described with respect to FIG. 12, or any aspect related to it. Note that reference to a processor performing a function of communications device 1400 may include one or more processors performing that function of communications device 1400.

As shown in FIG. 14, the communications device 1400 may include circuitry for receiving, from a network node via an access link, one or more reference signals associated with a monitoring procedure for an AI/ML model of the first UE (circuitry 1435).

As shown in FIG. 14, the communications device 1400 may include, stored in computer-readable medium/memory 1430, code for receiving, from a network node via an access link, one or more reference signals associated with a monitoring procedure for an AI/ML model of the first UE (code 1440).

As shown in FIG. 14, the communications device 1400 may include circuitry for performing the monitoring procedure for the AI/ML model of the first UE based at least in part on the one or more reference signals (circuitry 1445).

As shown in FIG. 14, the communications device 1400 may include, stored in computer-readable medium/memory 1430, code for performing the monitoring procedure for the AI/ML model of the first UE based at least in part on the one or more reference signals (code 1450).

As shown in FIG. 14, the communications device 1400 may include circuitry for transmitting, to a second UE via a sidelink, monitoring information associated with the AI/ML model of the first UE based at least in part on performing the monitoring procedure for the AI/ML model of the first UE (circuitry 1455).

As shown in FIG. 14, the communications device 1400 may include, stored in computer-readable medium/memory 1430, code for transmitting, to a second UE via a sidelink, monitoring information associated with the AI/ML model of the first UE based at least in part on performing the monitoring procedure for the AI/ML model of the first UE (code 1460).

Various components of the communications device 1400 may provide means for performing the method 1200 described with respect to FIG. 12, or any aspect related to it. For example, means for transmitting, sending, or outputting for transmission may include the transceiver(s) 254 and/or antenna(s) 252 of the UE 120 and/or transceiver 1408 and antenna 1410 of the communications device 1400 in FIG. 14. Means for receiving or obtaining may include the transceiver(s) 254 and/or antenna(s) 252 of the UE 120 and/or transceiver 1408 and antenna 1410 of the communications device 1400 in FIG. 14.

FIG. 14 is provided as an example. Other examples may differ from what is described in connection with FIG. 14.

The following provides an overview of some Aspects of the present disclosure:

Aspect 1: A method of wireless communication performed by a first UE, comprising: receiving, from a second UE via a sidelink, monitoring information associated with an AI/ML model of the second UE; and performing a monitoring procedure associated with an AI/ML model of the first UE based at least in part on the monitoring information associated with the AI/ML model of the second UE.

Aspect 2: The method of Aspect 1, wherein the AI/ML model of the first UE is associated with a beam management procedure.

Aspect 3: The method of any of Aspects 1-2, wherein the monitoring information includes at least one of a monitoring decision of a monitoring procedure for the AI/ML model of the second UE or monitoring key performance indicators used for the monitoring procedure for the AI/ML model of the second UE.

Aspect 4: The method of any of Aspects 1-3, wherein the monitoring procedure associated with the AI/ML model of the first UE is a procedure used to measure a performance of the AI/ML model of the first UE.

Aspect 5: The method of any of Aspects 1-4, wherein performing the monitoring procedure associated with the AI/ML model of the first UE includes using at least one of a monitoring decision of a monitoring procedure of the AI/ML model of the second UE, or monitoring key performance indicators used for the monitoring procedure of the AI/ML model of the second UE, for making a monitoring decision of the AI/ML model of the first UE.

Aspect 6: The method of any of Aspects 1-5, wherein the AI/ML model of the first UE and the AI/ML model of the second UE are the same model.

Aspect 7: The method of any of Aspects 1-6, wherein the AI/ML model of the first UE is associated with an AI/ML model structure and a first set of AI/ML model parameters, wherein the AI/ML model of the second UE is associated with the AI/ML model structure and a second set of AI/ML model parameters different from the first set of AI/ML model parameters.

Aspect 8: The method of any of Aspects 1-7, wherein the first UE and the second UE are of a same make of UE or a same model of UE.

Aspect 9: The method of any of Aspects 1-8, wherein the first UE is in communication with a network node and the second UE is in communication with the network node.

Aspect 10: The method of any of Aspects 1-9, further comprising receiving, from a network node via an access link, configuration information indicating that the second UE is associated with the AI/ML model of the second UE.

Aspect 11: The method of any of Aspects 1-10, wherein the monitoring information associated with the AI/ML model of the second UE includes at least one of: an indication that the second UE selected or is selecting the AI/ML model of the second UE from multiple AI/ML models, an indication that the second UE activated or is activating the AI/ML model of the second UE, an indication that the second UE deactivated or is deactivating the AI/ML model of the second UE, an indication that the second UE switched or is switching between the AI/ML model of the second UE and another AI/ML model, or an indication that that second UE switched or is switching between using the AI/ML model of the second UE and using a non-AI/ML beam management procedure.

Aspect 12: The method of any of Aspects 1-11, wherein the monitoring information is received via resources associated with one of a Mode 1 sidelink resource allocation procedure or a Mode 2 sidelink resource allocation procedure.

Aspect 13: The method of Aspect 12, wherein the resources are one of reserved, by a network node, for use by the second UE for the Mode 1 sidelink resource allocation procedure, or selected, by one of the first UE or the second UE, for use by the second UE for the Mode 2 sidelink resource allocation procedure.

Aspect 14: The method of any of Aspects 1-13, wherein the monitoring information associated with the AI/ML model of the second UE includes auxiliary information associated with a use case related to the second UE.

Aspect 15: The method of Aspect 14, wherein the auxiliary information associated with the use case related to the second UE includes at least one of a velocity of the second UE, an orientation of the second UE, or a signal blockage of the second UE.

Aspect 16: The method of Aspect 14, wherein performing the monitoring procedure associated with the AI/ML model of the first UE includes comparing the auxiliary information associated with the second UE to auxiliary information associated with a use case related to the first UE.

Aspect 17: The method of any of Aspects 1-16, wherein the AI/ML model of the first UE and the AI/ML model of the second UE are associated with a same model identifier.

Aspect 18: The method of any of Aspects 1-17, further comprising transmitting, to a network node via an access link, an indication associated with a monitoring decision by the first UE.

Aspect 19: A method of wireless communication performed by a first UE, comprising: receiving, from a network node via an access link, one or more reference signals associated with a monitoring procedure for an AI/ML model of the first UE; performing the monitoring procedure for the AI/ML model of the first UE based at least in part on the one or more reference signals; and transmitting, to a second UE via a sidelink, monitoring information associated with the AI/ML model of the first UE based at least in part on performing the monitoring procedure for the AI/ML model of the first UE.

Aspect 20: The method of Aspect 19, wherein the AI/ML model of the first UE is associated with a beam management procedure.

Aspect 21: The method of any of Aspects 19-20, wherein the monitoring information includes at least one of a monitoring decision of the monitoring procedure for the AI/ML model of the first UE or monitoring key performance indicators used for the monitoring procedure for the AI/ML model of the first UE.

Aspect 22: The method of any of Aspects 19-21, wherein the monitoring procedure includes performing measurements on the reference signals and comparing the measurements to outputs of the AI/ML model of the first UE.

Aspect 23: The method of any of Aspects 19-22, wherein the AI/ML model of the first UE and an AI/ML model of the second UE are the same model.

Aspect 24: The method of any of Aspects 19-23, wherein the AI/ML model of the first UE is associated with an AI/ML model structure and a first set of AI/ML model parameters, wherein an AI/ML model of the second UE is associated with the AI/ML model structure and a second set of AI/ML model parameters different from the first set of AI/ML model parameters.

Aspect 25: The method of any of Aspects 19-24, wherein the first UE and the second UE are a same make of UE or a same model of UE.

Aspect 26: The method of any of Aspects 19-25, wherein the first UE is in communication with the network node and the second UE is in communication with the network node.

Aspect 27: The method of any of Aspects 19-26, further comprising receiving, from the network node via the access link, configuration information indicating that the second UE is associated with an AI/ML model of the second UE.

Aspect 28: The method of any of Aspects 19-27, wherein the monitoring information associated with the AI/ML model of the first UE includes at least one of: an indication that the first UE selected or is selecting the AI/ML model of the first UE from multiple AI/ML models, an indication that the first UE activated or is activating the AI/ML model of the first UE, an indication that the first UE deactivated or is deactivating the AI/ML model of the first UE, an indication that the first UE switched or is switching between the AI/ML model of the first UE and another AI/ML model, or an indication that that first UE switched or is switching between using the AI/ML model of the first UE and using a non-AI/ML beam management procedure.

Aspect 29: The method of any of Aspects 19-28, wherein the monitoring information is transmitted via resources associated with one of a Mode 1 sidelink resource allocation procedure or a Mode 2 sidelink resource allocation procedure.

Aspect 30: The method of Aspect 29, wherein the resources are one of reserved, by the network node, for use by the first UE for the Mode 1 sidelink resource allocation procedure, or selected, by one of the first UE or the second UE, for use by the first UE for the Mode 2 sidelink resource allocation procedure.

Aspect 31: The method of any of Aspects 19-30, wherein the monitoring information associated with the AI/ML model of the first UE includes auxiliary information associated with a use case related to the first UE.

Aspect 32: The method of Aspect 31, wherein the auxiliary information associated with the use case related to the first UE includes at least one of a velocity of the first UE, an orientation of the first UE, or a signal blockage of the first UE.

Aspect 33: The method of any of Aspects 19-32, wherein the AI/ML model of the first UE and the AI/ML model of the second UE are associated with a same model identifier.

Aspect 34: The method of any of Aspects 19-33, further comprising transmitting, to the network node via the access link, an indication associated with a monitoring decision by the first UE.

Aspect 35: An apparatus for wireless communication at a device, comprising a processor; memory coupled with the processor; and instructions stored in the memory and executable by the processor to cause the apparatus to perform the method of one or more of Aspects 1-34.

Aspect 36: A device for wireless communication, comprising a memory and one or more processors coupled to the memory, the one or more processors configured to perform the method of one or more of Aspects 1-34.

Aspect 37: An apparatus for wireless communication, comprising at least one means for performing the method of one or more of Aspects 1-34.

Aspect 38: A non-transitory computer-readable medium storing code for wireless communication, the code comprising instructions executable by a processor to perform the method of one or more of Aspects 1-34.

Aspect 39: A non-transitory computer-readable medium storing a set of instructions for wireless communication, the set of instructions comprising one or more instructions that, when executed by one or more processors of a device, cause the device to perform the method of one or more of Aspects 1-34.

The foregoing disclosure provides illustration and description but is not intended to be exhaustive or to limit the aspects to the precise forms disclosed.

Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, andc+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules, and circuits described in connection with the present disclosure may be implemented or performed with a general purpose processor, a digital signal processor (DSP), an application-specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices (e.g., a combination of a DSP and a microprocessor, a plurality of microprocessors, one or more microprocessors in conjunction with a DSP core, a system on a chip (SoC), or any other such configuration).

As used herein, the term “determining” encompasses a wide variety of actions. For example, “determining” may include calculating, computing, processing, deriving, investigating, looking up (e.g., looking up in a table, a database, or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or a processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A first user equipment (UE) configured for wireless communications, comprising:
one or more memories comprising processor-executable instructions; and
one or more processors configured to execute the processor-executable instructions and cause the first UE to:
receive, from a second UE via a sidelink, monitoring information associated with an artificial intelligence (AI)/machine learning (ML) model of the second UE; and
perform a monitoring procedure associated with an AI/ML model of the first UE based at least in part on the monitoring information associated with the AI/ML model of the second UE.

2. The first UE of claim 1, wherein the AI/ML model of the first UE is associated with a beam management procedure.

3. The first UE of claim 1, wherein the monitoring information includes at least one of a monitoring decision of a monitoring procedure for the AI/ML model of the second UE or monitoring key performance indicators used for the monitoring procedure for the AI/ML model of the second UE.

4. The first UE of claim 1, wherein the monitoring procedure associated with the AI/ML model of the first UE is a procedure used to measure a performance of the AI/ML model of the first UE.

5. The first UE of claim 1, wherein the one or more processors, to cause the first UE to perform the monitoring procedure associated with the AI/ML model of the first UE, are configured to cause the first UE to use at least one of a monitoring decision of a monitoring procedure of the AI/ML model of the second UE, or monitoring key performance indicators used for the monitoring procedure of the AI/ML model of the second UE, for making a monitoring decision of the AI/ML model of the first UE.

6. The first UE of claim 1, wherein the AI/ML model of the first UE and the AI/ML model of the second UE are the same model.

7. The first UE of claim 1, wherein the AI/ML model of the first UE is associated with an AI/ML model structure and a first set of AI/ML model parameters, and wherein the AI/ML model of the second UE is associated with the AI/ML model structure and a second set of AI/ML model parameters different from the first set of AI/ML model parameters.

8. The first UE of claim 1, wherein the first UE and the second UE are of a same make of UE or a same model of UE.

9. The first UE of claim 1, wherein the first UE is in communication with a network node and the second UE is in communication with the network node.

10. The first UE of claim 1, wherein the one or more processors are further configured to cause the first UE to receive, from a network node via an access link, configuration information indicating that the second UE is associated with the AI/ML model of the second UE.

11. The first UE of claim 1, wherein the monitoring information associated with the AI/ML model of the second UE includes at least one of:
an indication that the second UE selected or is selecting the AI/ML model of the second UE from multiple AI/ML models,
an indication that the second UE activated or is activating the AI/ML model of the second UE,
an indication that the second UE deactivated or is deactivating the AI/ML model of the second UE,
an indication that the second UE switched or is switching between the AI/ML model of the second UE and another AI/ML model, or
an indication that that second UE switched or is switching between using the AI/ML model of the second UE and using a non-AI/ML beam management procedure.

12. The first UE of claim 1, wherein the monitoring information is received via resources associated with one of a Mode 1 sidelink resource allocation procedure or a Mode 2 sidelink resource allocation procedure.

13. The first UE of claim 12, wherein the resources are one of reserved, by a network node, for use by the second UE for the Mode 1 sidelink resource allocation procedure, or selected, by one of the first UE or the second UE, for use by the second UE for the Mode 2 sidelink resource allocation procedure.

14. The first UE of claim 1, wherein the monitoring information associated with the AI/ML model of the second UE includes auxiliary information associated with a use case related to the second UE.

15. The first UE of claim 14, wherein the auxiliary information associated with the use case related to the second UE includes at least one of a velocity of the second UE, an orientation of the second UE, or a signal blockage of the second UE.

16. The first UE of claim 14, wherein the one or more processors, to cause the first UE to perform the monitoring procedure associated with the AI/ML model of the first UE, are configured to cause the first UE to compare the auxiliary information associated with the second UE to auxiliary information associated with a use case related to the first UE.

17. The first UE of claim 1, wherein the AI/ML model of the first UE and the AI/ML model of the second UE are associated with a same model identifier.

18. The first UE of claim 1, wherein the one or more processors are further configured to cause the first UE to transmit, to a network node via an access link, an indication associated with a monitoring decision by the first UE.

19-28. (canceled)

29. A method of wireless communication performed by a first user equipment (UE), comprising:
receiving, from a second UE via a sidelink, monitoring information associated with an artificial intelligence (AI)/machine learning (ML) model of the second UE; and
performing a monitoring procedure associated with an AI/ML model of the first UE based at least in part on the monitoring information associated with the AI/ML model of the second UE.

30. (canceled)
